(19) United States
(12) Patent Application Publication
(10) Pub. No.: US 2026/0289169 A1
(43) Pub. Date: Sep. 24, 2026

(54) SYSTEM

(71) Applicant: SoftBank Group Corp., Tokyo (JP)

(72) Inventor: Kengo UCHIHARA, Tokyo (JP)

(73) Assignee: SoftBank Group Corp., Tokyo (JP)

(21) Appl. No.: 19/564,177

(22) Filed: Mar. 12, 2026

(30) Foreign Application Priority Data
Mar. 19, 2025 (JP) 2025-044960

(51) Int. Cl. G06F 40/40; G06F 40/103; G06F 40/166; G06F 40/205; G06F 40/284; G06Q 10/02; G06V 30/412; H04L 9/40

(52) U.S. Cl. CPC G06F 40/40; G06F 40/103; G06F 40/166; G06F 40/205; G06F 40/284; G06Q 10/02; G06V 30/412; H04L 63/166

(57) ABSTRACT

A system includes a processor that is configured to: receive a text input in natural language from a user, preprocess the received text by performing normalization, tokenization, and removal of unnecessary information, and analyze the preprocessed text by inputting the preprocessed text into a generative artificial intelligence model using a prompt that instructs the generative artificial intelligence model to extract reservation information, to thereby extract the reservation information.

### CROSS-REFERENCE TO RELATED APPLICATION

This application is based on and claims priority under 35 USC 119 from Japanese Patent Application No. 2025-044960 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional reservation systems generally require users to interact with structured user interfaces such as forms, drop-down menus, or fixed templates, and therefore do not allow users to make reservations in a flexible natural-language manner. As a result, the user must understand and follow predefined input formats, which increases the cognitive burden and reduces usability, particularly for users who are not familiar with the system. Furthermore, when natural-language text input is accepted, conventional systems often lack robust preprocessing and structured extraction mechanisms, so that noise, ambiguity, and variations in expression in the input text can lead to incorrect or incomplete extraction of reservation information. In addition, even when reservation information is successfully extracted, conventional systems do not always provide a standardized mechanism for presenting the extracted information to the user in a machine-readable and human-readable format, nor do they provide a secure and reliable mechanism for transmitting the extracted reservation information to external reservation systems. Accordingly, there is a need for a system that can: accurately accept natural-language text input from a user; reliably preprocess and analyze the text using a generative artificial intelligence model to extract reservation information; present the extracted reservation information in a structured, displayable format; and securely transmit the reservation information to external reservation systems.

### SUMMARY

In order to solve the above-described problems, an aspect of the present invention provides a system comprising a processor, wherein the processor is configured to receive a text input in natural language from a user, preprocess the received text by performing normalization, tokenization, and removal of unnecessary information, and analyze the preprocessed text by inputting the preprocessed text into a generative artificial intelligence model using a prompt that instructs the generative artificial intelligence model to extract reservation information, to thereby extract the reservation information. The processor is further configured, in some embodiments, to format the extracted reservation information in a HyperText Markup Language format and transmit the formatted reservation information to a terminal of the user so that the user can visually confirm the extracted reservation information in a structured and human-readable representation. The processor is also configured, in some embodiments, to package the reservation information into data of a HyperText Transfer Protocol POST request and transmit the data via a secure communication protocol to an external reservation system, thereby enabling automated and secure integration of the extracted reservation information with external systems. By these means, the system enables accurate extraction of reservation information from natural-language text input, improves the usability of reservation operations for the user, and ensures reliable and secure communication of the reservation information to external reservation systems.

The term “system” refers to a combination of hardware and/or software components including at least one processor configured to execute programmed instructions to perform the functions described in the claims.

The term “processor” refers to a hardware device or a combination of hardware and software, such as a central processing unit (CPU), graphics processing unit (GPU), microcontroller, or dedicated processing circuitry, that executes instructions to perform operations specified in the claims.

The term “text input in natural language” refers to a sequence of characters or words expressed in a human language, such as English or Japanese, that is provided by a user without being constrained to a rigidly predefined command or form structure.

The term “user” refers to a human operator or person who interacts with the system, for example by providing text input in natural language and receiving output from the system. The term “preprocess” refers to a series of operations performed on received text prior to analysis, including at least normalization, tokenization, and removal of unnecessary information, in order to convert the text into a form suitable for processing by a model.

The term “normalization” refers to transforming text into a standardized representation, including at least one of converting character cases, unifying character encodings, standardizing date and time expressions, or removing extraneous whitespace or symbols.

The term “tokenization” refers to segmenting text into smaller units, such as words, subwords, or symbols, which are then used as input elements for subsequent analysis or modeling.

The term “unnecessary information” refers to portions of the received text that are not required for extraction of reservation information, such as filler words, certain punctuation marks, or irrelevant phrases, which may be removed to improve analysis accuracy.

The term “generative artificial intelligence model” refers to a machine learning model, such as a large language model or neural network, configured to generate or transform text and to output structured or unstructured results in response to a given input and prompt.

The term “prompt” refers to a text or data sequence provided as part of the input to the generative artificial intelligence model, which instructs or guides the model to perform a specific task, such as extracting reservation information from the preprocessed text.

The term “reservation information” refers to structured data representing details related to a reservation, including at least one of a date, time, location, facility name, service type, number of people, or other parameters needed to make or manage a reservation.

The term “analyze the preprocessed text” refers to processing the preprocessed text using the generative artificial intelligence model and the prompt to identify and extract reservation information from the text.

The term “format the extracted reservation information in a HyperText Markup Language format” refers to generating one or more documents or fragments using HyperText Markup Language (HTML) tags so that the extracted reservation information can be rendered or displayed by a web browser or equivalent user interface.

The term “terminal” refers to an electronic device operated by the user, such as a smartphone, tablet, personal computer, or web-enabled device, that can send text input to the system and receive output such as formatted reservation information.

The term “HyperText Markup Language format” refers to a representation of information using HTML tags and structure, enabling the information to be displayed in a browser or browser-like environment.

The term “package the reservation information into data of a HyperText Transfer Protocol POST request” refers to encapsulating the reservation information in a payload of an HTTP

POST message, for example as a body encoded in a structured format such as JSON, XML, or form data, for transmission to another system.

The term “HyperText Transfer Protocol POST request” refers to a network request method defined in the HyperText Transfer Protocol (HTTP) that is used to submit data to a server for processing, where the data is included in the body of the request.

The term “secure communication protocol” refers to a communication protocol that provides at least confidentiality and integrity protection for transmitted data, such as Transport Layer Security (TLS), Secure Sockets Layer (SSL), or equivalent security mechanisms.

The term “external reservation system” refers to a system separate from the claimed system, operated by a third party or another entity, that receives reservation information and processes reservations, such as a restaurant booking system, hotel booking system, or other reservation management system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

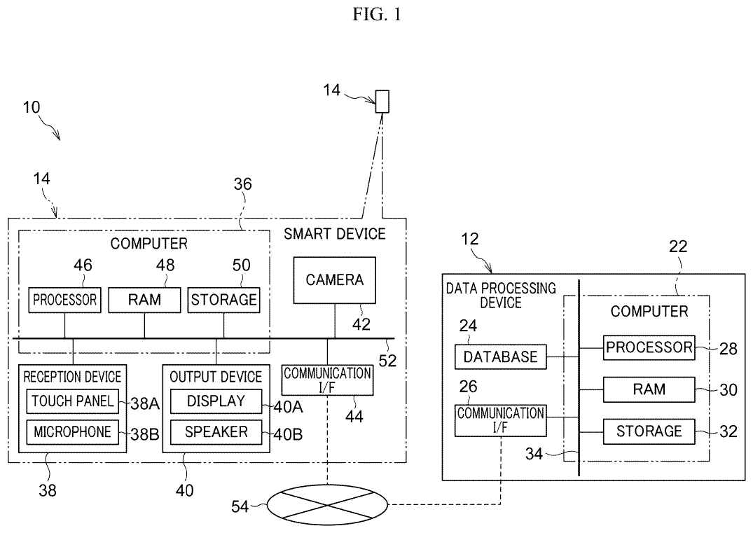

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

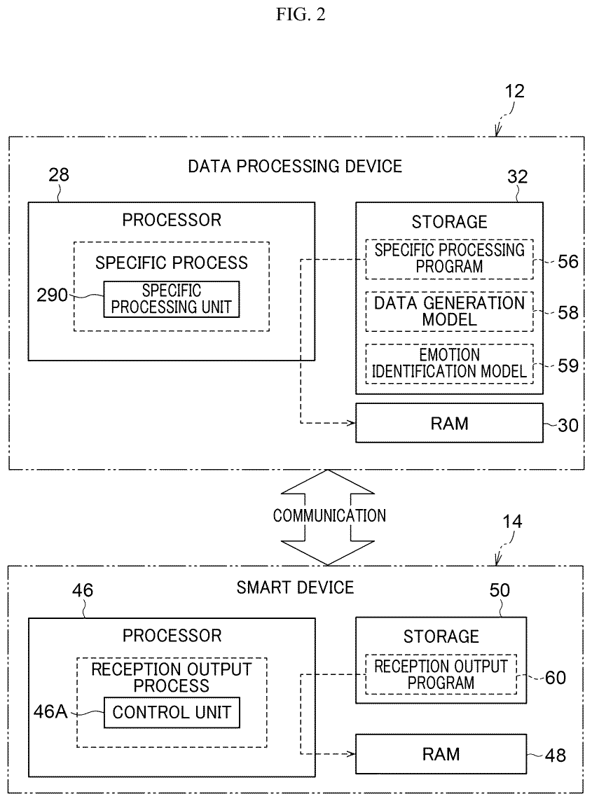

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented reservation systems generally require users to enter structured data into predetermined forms, such as separate fields for date, time, location, facility, and number of persons. When a user inputs reservation intent as free-form natural language text, existing systems typically rely on rigid keyword matching or simple pattern recognition. These approaches are unable to robustly handle variations in user expressions, mixed languages, typographical errors, or ambiguous temporal expressions, and therefore fail to reliably convert natural language into machine-usable reservation data. As a result, substantial manual intervention by a human operator or additional corrective input by the user is required, which increases latency, reduces throughput, and degrades user experience. From the perspective of computer technology, many known solutions simply place a general-purpose natural language model in front of an existing reservation engine without introducing any structured interface or validation between them. In such architectures, raw model output is treated as opaque text and directly passed to backend applications. This lack of structured prompting, normalization, and validation introduces technical problems, including inconsistent data formats, parsing failures, and propagation of recognition errors into downstream systems. These problems manifest as increased error rates in automated booking, higher load on backend services due to repeated failures, and complex exception-handling logic dispersed across the system, thereby reducing maintainability and scalability of the computer system.

Furthermore, conventional systems do not fully leverage the capabilities of generative artificial intelligence models in a controlled and verifiable manner. In particular, they lack a mechanism to (i) normalize noisy natural language input at the system boundary, (ii) generate task-specific prompt sentences that constrain model behavior and request structured output, (iii) programmatically validate the structured output, and (iv) iteratively refine the prompt when missing or invalid items are detected. In the absence of these mechanisms, the computer system behaves unpredictably, and the integration of generative models with transactional reservation backends remains fragile and unreliable.

Accordingly, there is a need for a computer-implemented technique that improves the way a server processes natural language reservation requests by introducing a structured pipeline including text normalization, prompt sentence generation for a generative AI model, structured output analysis, and automated interaction with external reservation systems. Such a technique should reduce the dependency on manual data correction, improve the reliability of data passed to external reservation services, and provide a more efficient and technically robust reservation processing architecture that enhances the functioning of the underlying computer system itself.

The specific processing by the specific processing unit 290 of the data processing device 12 in Example 1 is realized by the following means.

The present invention provides a server comprising a processor and a memory storing instructions that, when executed by the processor, cause the processor to receive natural-language character information from a user terminal through a communication network, perform normalization preprocessing on the character information including character-type unification, encoding normalization, removal of unnecessary blank characters and control symbols, and conversion of full-width characters into half-width characters, generate a task-specific prompt sentence that embeds the preprocessed character information and explicitly requests extraction of reservation-related items as structured data, transmit the generated prompt sentence to a generative artificial intelligence model that executes natural language processing, receive response data including reservation information from the generative artificial intelligence model, analyze the response data to obtain a structured representation of the reservation information categorized into date data, time data, geographic region data, facility identification data, and number-of-persons data, validate a format and value range of the structured representation and, when a missing or invalid item is detected, automatically modify the prompt sentence to request additional input and retransmit the modified prompt sentence to the generative artificial intelligence model, convert validated reservation information into display data in a standardized markup format and transmit the display data to the user terminal for user confirmation or correction, and, upon receiving confirmed or corrected reservation information, package the reservation information according to a communication specification of an external reservation-processing system and transmit the packaged reservation information to the external reservation-processing system using a secure communication protocol while generating and returning result notification information to the user terminal based on a reservation-processing result received from the external reservation-processing system. This enables the computer system to more reliably transform unstructured natural language reservation requests into validated, structured reservation data with reduced manual intervention, to decrease processing errors and retries in communication with external reservation backends, and to improve overall system performance, robustness, and scalability by providing a controlled, technically enhanced interface between generative artificial intelligence models and transactional reservation-processing components.

The term “system” refers to an aggregation of hardware components and software components that cooperate to execute reservation-related processing, including at least a server device and one or more user terminals connected via a communication network.

The term “processor” refers to a hardware-based computation unit, such as a central processing unit or a processing core, that executes machine-readable instructions to perform logical operations, data processing operations, and control operations.

The term “memory” refers to a hardware storage resource, such as volatile memory or non-volatile memory, that stores instructions and data for access and execution by the processor.

The term “user terminal” refers to an information processing device operated by a user, such as a personal computer, a mobile device, or any other computing apparatus capable of inputting natural-language text and displaying reservation-related information.

The term “communication network” refers to a wired or wireless data transmission infrastructure, such as a local area network, a wide area network, or the Internet, that enables data exchange between the server and the user terminal and between the server and an external system.

The term “natural language” refers to a human language used for everyday communication, represented as character sequences or text strings, and not restricted to predefined command formats or structured form inputs.

The term “character information” refers to data composed of a sequence of characters or symbols encoded according to a character encoding scheme and representing natural-language content.

The term “normalization preprocessing” refers to a series of data transformation operations applied to received character information, including operations such as unifying character types, normalizing encoding, and removing unnecessary symbols, in order to standardize the text format for downstream processing.

The term “character-type unification” refers to processing that converts characters of various forms, such as variants of the same symbol, into a standardized form to reduce variability in input text.

The term “encoding normalization” refers to processing that converts character data represented in different encoding forms or normalization forms into a single, consistent encoding representation.

The term “unnecessary blank characters and control symbols” refers to spaces, tab characters, newline characters, and non-printable control characters that are not required for semantic interpretation of reservation intent.

The term “full-width characters” refers to character representations occupying a uniform, wider cell width, such as those used in some writing systems for letters, numbers, and symbols.

The term “half-width characters” refers to character representations occupying a narrower cell width, generally used as a standard-width representation of letters, numbers, and symbols.

The term “task-specific prompt sentence” refers to a text string constructed by the server that embeds preprocessed character information and includes instructions tailored to a specific computational task, such as extracting reservation information, for input to a generative artificial intelligence model.

The term “prompt sentence” refers to a text input supplied to a generative artificial intelligence model that defines a task, constraints, and context in order to influence and control the model's output.

The term “generative artificial intelligence model” refers to a machine-learned model, such as a neural network-based language model, configured to generate or transform text output in response to input text, and capable of performing natural language processing tasks including information extraction.

The term “natural language processing” refers to a class of computational techniques by which a computer system analyzes, interprets, and transforms natural-language text. The term “response data” refers to data returned by the generative artificial intelligence model or an external reservation-processing system in response to a request, the data including at least reservation-related information or a processing result.

The term “reservation information” refers to structured or semi-structured data elements representing a reservation request, including at least date information, time information, location information, facility information, and number-of-persons information, and optionally additional conditions.

The term “structured data” refers to data organized according to a predefined schema, such as a set of named fields or keys and associated values, which can be programmatically parsed and validated.

The term “date data” refers to an item of structured data representing a calendar date associated with a reservation.

The term “time data” refers to an item of structured data representing a time of day or time period associated with a reservation.

The term “geographic region data” refers to an item of structured data representing a location or area, such as a city, region, or other geographic entity, associated with a reservation.

The term “facility identification data” refers to an item of structured data that identifies a facility, such as a restaurant, lodging facility, or other venue, and that may correspond to an internal identifier or external identifier for the facility.

The term “number-of-persons data” refers to an item of structured data representing a quantity of persons or guests included in a reservation.

The term “internal storage” refers to a storage resource accessible by the processor, such as a memory device or storage device, used to store structured data and intermediate processing results.

The term “display data” refers to data formatted for presentation on a user interface, including values and layout information used to render reservation information on a display device.

The term “display format” refers to a specification of how reservation information is arranged and encoded for presentation, including definitions of fields, labels, and layout structures.

The term “standardized markup format” refers to a representation of data using a structured notation, such as a text-based tagging or markup scheme, that separates information by item and can be interpreted by a user interface renderer.

The term “confirmation information” refers to display data that presents extracted reservation information to a user for verification, acceptance, or modification.

The term “correction” refers to a modification, by the user or by system logic, of reservation information that has been initially extracted or generated, in order to improve accuracy or completeness.

The term “external information processing system” refers to a computer system separate from the described server that performs reservation processing, such as a booking management system, and that communicates with the server through a defined interface.

The term “communication specification” refers to a set of rules and formats that define how data is packaged, transmitted, and interpreted between the server and an external system.

The term “transmission data” refers to data that has been organized and formatted according to a communication specification for sending to an external information processing system.

The term “secure communication procedure” refers to a communication method that protects data against unauthorized access or tampering during transmission, such as a protocol employing encryption and integrity verification.

The term “reservation processing result” refers to information returned from an external information processing system indicating an outcome of a reservation operation, such as confirmation, rejection, or error details.

The term “result notification information” refers to data derived from a reservation processing result, formatted for presentation to the user on the user terminal, and indicating the status and details of the reservation.

The term “structured representation” refers to an organized form of data output by the generative artificial intelligence model, such as a key-value set or object, which associates reservation-related items with corresponding values.

The term “format verification” refers to processing that checks whether a structured representation conforms to a predetermined syntactic scheme, such as a required set of fields and data types.

The term “value validity determination” refers to processing that checks whether values in a structured representation satisfy predetermined conditions, such as acceptable ranges, allowed patterns, or logical consistency.

The term “missing item” refers to an element of reservation information that is required according to a predetermined schema but is absent or left unspecified in the structured representation.

The term “invalid item” refers to an element of reservation information that is present in the structured representation but fails to meet a required format, value constraint, or logical condition.

The term “additional input” refers to supplementary information that is requested from the generative artificial intelligence model or the user in order to fill missing reservation items or correct invalid reservation items.

In one embodiment, a server, a terminal, and a user cooperate to implement the invention. The server includes at least one processor, a memory, a network interface, and a non-transitory storage device. The server runs a server-side program on an operating system such as a general-purpose server operating system, and uses a web application framework such as a typical HTTP application framework to provide an application programming interface (API). The terminal includes a processor, a memory, a display device, and an input device such as a keyboard or touch panel. The terminal runs a client application such as a web browser or a native application to communicate with the server via a communication network such as the Internet.

The server stores, in the memory, a plurality of software modules including at least: a text reception module, a preprocessing module, a prompt generation module, an artificial intelligence communication module, a response parsing module, a validation module, a reservation packaging module, and a user interface formatting module. The server further stores configuration data and mapping tables in the storage device, including a facility table, a city table, and a schema definition for reservation data.

The terminal displays a user interface that allows the user to input natural-language text expressing a reservation request. The terminal operates an input component, for example, a text box or a chat-style interface, and records the user's keystrokes as a string in a character encoding such as UTF-8. The terminal sends this string to the server via an HTTP request over a secure transport such as TLS.

The server receives the natural-language text via the text reception module. The server then uses the preprocessing module to perform normalization on the received text. The server applies character-type unification by converting variant forms of letters and numbers into a single canonical form using text-processing libraries. The server performs encoding normalization by converting the character string into a single normalization form so that equivalent characters share an identical binary representation. The server removes unnecessary blank characters and control symbols by applying deterministic rules, such as deleting redundant whitespace characters, non-printable codes, and decorative symbols that do not contribute to semantic interpretation. The server also converts full-width characters to half-width characters to create a unified representation of alphanumeric characters and punctuation.

The server stores both the original text and the normalized text in separate fields of a data structure in the memory. For example, the server uses a structured object comprising keys “original_text” and “normalized_text,” along with metadata such as a user identifier and a timestamp. The server's data structures are defined so that downstream modules can access and update these fields without ambiguity.

The server uses the prompt generation module to construct a task-specific prompt sentence.

The server embeds the normalized text into a template that defines the extraction task and output constraints. In one example, the server generates the following prompt sentence:

“You are a system that extracts reservation information from user input. Extract date, time, city, venue name, number of people, and any special notes. Respond only in JSON with keys: date, time, location_city, venue_name, number_of_people, notes. User input: ‘Tomorrow at 3 pm I want to reserve a table at Restaurant A in Tokyo for two people.’”

In another example, the server generates a prompt sentence:

“Extract reservation information (date, time, location, venue name, number of people, and notes) from the following user input. Answer with structured data that can be parsed deterministically. User input: ‘Next Friday I want a double room at Hotel B in Osaka for two nights for two adults.’”

In each case, the server constructs the prompt so that the generative AI model is instructed to output a structured representation that matches a predetermined schema. The server maintains this template in configuration so that modifications to the output format can be centrally managed.

The server uses the artificial intelligence communication module to send the generated prompt sentence to a generative AI model. The generative AI model is implemented as a transformer-based neural network that receives tokenized text and outputs probability distributions over token sequences. The model architecture includes an embedding layer, multiple self-attention layers, feed-forward layers, and an output projection layer. The generative AI model can be deployed as a service reachable by the server through a network interface. The server calls the model via an API that accepts the prompt sentence as an input parameter.

The generative AI model internally performs tokenization, converting the prompt sentence into discrete tokens based on a subword segmentation algorithm. The model then applies multi-head self-attention to compute contextual representations for each token and uses stacked transformer layers to propagate contextual information. The model has been trained on a large training set that includes text sequences and corresponding targets. During training, the model minimized an error function, for example, a cross-entropy loss between predicted token distributions and actual target tokens. The model updated its parameters via gradient-based optimization methods. In some embodiments, the model was fine-tuned on domain-specific reservation examples by minimizing a loss function that penalized incorrect extraction of date, time, location, venue, and number-of-persons items. The training dataset may include augmented examples generated by paraphrasing and time-expression variation to improve robustness against input diversity.

The server does not rely on generic “AI judgment” but instead uses the generative AI model as a deterministic transformation function defined by its trained parameters and architecture. The server constrains the model's behavior by specifying in the prompt sentence the desired output schema and by setting decoding parameters such as a low temperature to reduce randomness in output token selection.

The server receives output text from the generative AI model as response data. The response parsing module in the server interprets the output text as a structured representation. In one embodiment, the model output follows a key-value pattern consistent with the schema requested in the prompt, for example, containing explicit labels for “date,” “time,” “location_city,” “venue_name,” “number_of_people,” and “notes.” The server uses deterministic parsing rules to extract these values. The server maps the extracted values into an internal data object that corresponds to the reservation schema. This object includes typed fields, such as a date type, a time type, a numeric type for number-of-persons, and string types for city, venue, and notes.

The server uses the validation module to perform format verification and value validity determination on the structured representation. The server checks whether the output includes all required fields and whether each field conforms to a predefined format. For date data, the server attempts to parse the string using a date-parsing algorithm and verifies that the resulting date lies within an acceptable range. For time data, the server converts various expressions such as “7 μm,” “19:00,” or “this evening” into a standardized time representation. For number-of-persons data, the server converts textual numbers (such as “two” or “four”) into integers and enforces constraints on allowable ranges. For geographic region data and facility identification data, the server compares the extracted text against entries in the facility table and city table using matching algorithms that may include exact matching and similarity-based matching. If ambiguities are detected, the server records them as error codes within the data object.

When the validation module determines that any item is missing or invalid, the server modifies the prompt sentence. The server incorporates feedback into the prompt by adding explicit language that requests clarification of the missing or invalid items. For instance, the server generates an updated prompt sentence such as:

“The previous extraction missed some items or contained invalid values. Based on the same user input, provide values for all of the following keys: date, time, location_city, venue_name, number_of_people, notes. Ensure that all values are explicit and machine-readable. User input: ‘Tomorrow at 3 μm I want to reserve a table at Restaurant A in Tokyo for two people.’”

The server then sends the updated prompt to the generative AI model again, thus implementing an iterative refinement loop that operates according to well-defined rules. This controlled iteration allows the server to recover from incomplete or inconsistent AI outputs without human intervention, improving robustness and reducing error propagation.

The server uses the user interface formatting module to convert validated reservation information into display data in a standardized markup format. The server represents each item of reservation information, such as date, time, city, venue, and number of people, as separate elements with associated labels and attributes governing editability. The server transmits this display data to the terminal.

The terminal receives the display data and renders it on the display device. The terminal presents each item as an editable input region so that the user can verify and, if necessary, modify the extracted information. The terminal transmits any modifications back to the server, which updates the internal data object with the corrected values. Because the server has already validated structural and format constraints, the user's corrections are applied in a context where ambiguity and inconsistency have been substantially reduced.

The server then uses the reservation packaging module to communicate with an external reservation-processing system. The server selects a communication profile based on the facility identification data, and packages the reservation information into transmission data that follows the external system's communication specification. The server uses a secure communication protocol to send the request and receives a reservation processing result. The server parses this result, updates its internal data structures with confirmation codes or error codes, and generates result notification information to send back to the terminal.

The terminal displays the reservation processing result on the screen so that the user can see the final status, including confirmation identifiers and any relevant instructions. The user can optionally store the confirmation information in another application or display it at a later time.

This architecture improves computer technology in several ways. The server's preprocessing module reduces input variability at the boundary of the system, which decreases the complexity of subsequent parsing and validation. By converting text into a normalized representation, the server reduces the number of distinct patterns that the generative AI model and validation module must handle, resulting in faster execution and fewer parsing failures.

The prompt generation module and validation module together create a controlled interaction pattern with the generative AI model. Instead of passing arbitrary model output directly to downstream components, the server enforces a schema and iteratively refines model outputs based on explicit rules. This decreases the likelihood of malformed data, reduces the need for ad hoc exception handling, and improves throughput by lowering the number of failed reservation submissions. The controlled schema also enables simpler and more efficient data structures in memory, which can be indexed and cached effectively.

The generative AI model is used not as a generic assistant but as a specialized component in a data transformation pipeline. The model architecture, with multi-head attention and large parameter matrices, allows the system to capture complex dependencies in user input, such as relative date expressions, nested constraints, and co-references. Because the model has been trained with a loss function that directly reflects prediction accuracy for token sequences, and optionally fine-tuned for reservation-oriented patterns, the model can represent temporal and semantic relationships that are difficult to encode in rule-based systems. This leads to improved extraction accuracy beyond what a human operator with simple tools or a conventional keyword system can achieve, especially under high volume and expression diversity.

The validation and iterative prompting mechanism enables the server to reduce uncertainty in a computationally efficient way. Instead of prompting a human operator to resolve ambiguity, the server constructs refined prompts that guide the generative AI model to correct missing or invalid items. The server uses explicit algorithmic rules to determine when to launch another AI request and what additional constraints to specify. This closed-loop process reduces manual intervention and improves latency without merely automating a human workflow; it alters the internal operation of the computer system by embedding a feedback-driven, schema-based error correction mechanism that is specific to machine processing.

The data structures used by the server are designed to support efficient indexing, caching, and logging. The server stores normalized text, structured reservation objects, validation flags, and interaction logs with the generative AI model. This enables the server to reuse previous normalization results, quickly search for similar past reservations, and adjust prompting strategies based on historical error patterns. As a result, computational resources are used more efficiently, and communication overhead between the server and external systems is reduced because malformed or incomplete reservations are filtered out at an earlier stage.

Alternative embodiments can be implemented. The server can use a different type of generative AI model, such as a sequence-to-sequence model trained with an encoder-decoder architecture, where the encoder transforms input tokens into a latent representation and the decoder generates structured textual output. The server can adjust the prompt sentence to request output in a tag-based format instead of key-value expressions, while maintaining deterministic parsing rules. The server can also deploy multiple models specialized for different domains, such as restaurant reservations, hotel reservations, or transportation reservations, and select a model based on preliminary classification of the input text.

The server can integrate a rule-based pre-classifier that analyzes the normalized text to detect language, domain, and complexity level, and routes the request to an appropriate generative AI model configuration. The server can further adjust decoding parameters, such as beam width and maximum output length, based on detected characteristics, thereby optimizing computational load and response time. The server may also maintain a fallback path where if the generative AI model repeatedly fails to produce valid structured data after several iterations, the server triggers a simplified form input on the terminal, thus ensuring continuity of service while preserving the main advantage of automated natural-language processing. The terminal can be implemented on various hardware platforms, including mobile devices, embedded devices, and desktop computers. The user interface can be adapted to each form factor but remains logically consistent: the terminal always collects free-form natural-language text, displays extracted structured information, and presents finalized reservation results.

Through these embodiments, the server, terminal, and user cooperate within a concrete computational architecture. The system as a whole produces technical effects including improved extraction accuracy, reduced latency, reduced error propagation, more efficient use of network bandwidth through fewer failed transactions, and a more robust and scalable reservation-processing pipeline. These improvements arise from specific data structures, controlled prompt sentence generation, structured output validation, and iterative AI interaction, rather than from a mere automation of human reservation tasks.

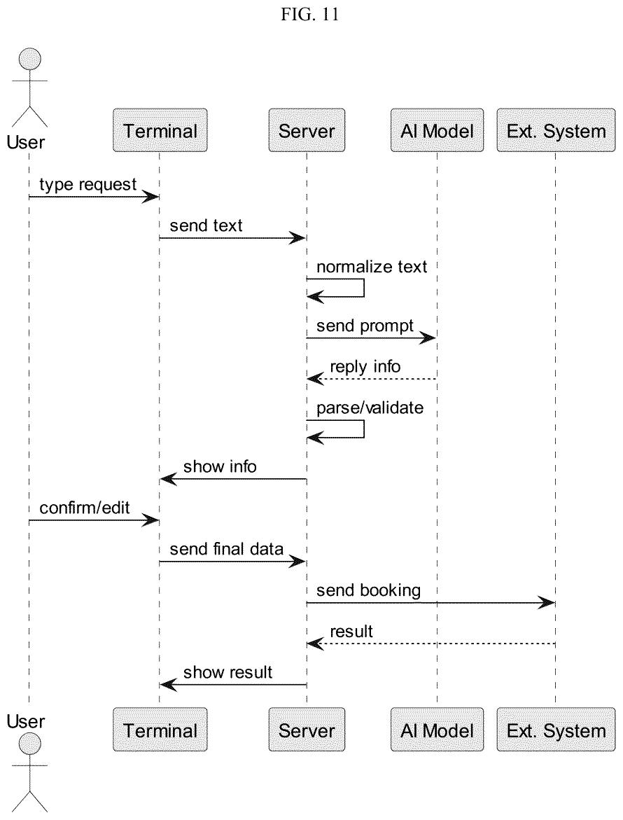

The following describes the processing flow using FIG. 11.

### Step 1:

User inputs reservation text on the terminal.

User operates an input interface, such as a text box or chat window, and types a natural-language sentence describing a reservation request, for example, “Tomorrow at 3 μm I want to reserve a table at Restaurant A in Tokyo for two people.” The input is a sequence of characters captured by the operating system's input subsystem and stored as a UTF-8 string in the terminal's application memory. Terminal takes this UTF-8 string as input data and wraps it into a request object containing at least the text, a user identifier, and a timestamp. Terminal then outputs an HTTP or HTTPS request message that includes the natural-language text in the body, formatted as a payload suitable for transmission to the server's API endpoint.

### Step 2:

Terminal transmits the user's text to the server.

Terminal uses a network stack, such as TCP/IP over Wi-Fi or cellular communication, to send the HTTP(S) request containing the user's natural-language text to the server. The input to this step is the request object generated in Step 1; the output is a network packet stream addressed to the server's network interface. Terminal encapsulates the request in transport and network layer headers and hands the data to the communication hardware for transmission, thereby converting the in-memory request object into a sequence of bytes on the network.

### Step 3:

Server receives and decodes the natural-language text.

Server, via its network interface and web server software, receives the HTTP(S) request from the terminal. The input to this step is the incoming network packet stream. Server reassembles the packets at the transport layer, decrypts the payload if HTTPS is used, and passes the HTTP request to an application framework. Server parses the request headers and body, extracts the character data representing the user's natural-language text, and decodes it from the wire format back into an internal string representation. The output of this step is a server-side data structure that contains the raw text, user identifier, and associated metadata, stored in system memory.

### Step 4:

Server performs text normalization and cleaning.

Server invokes a preprocessing module on the raw text string. The input to this step is the unprocessed natural-language text stored in the server-side data structure. Server executes multiple deterministic transformations: server removes unnecessary blank characters and control symbols by applying pattern-matching functions, replaces multiple spaces with single spaces, and deletes non-printable characters. Server unifies character types by converting variant forms into canonical forms, and converts full-width characters into half-width characters for digits and alphabetic characters. Server also normalizes the encoding form, for example, by converting the text to a standard Unicode normalization form, so that equivalent characters share the same code point sequence. These operations perform data cleaning and canonicalization on the input string. The output is a normalized text string that is easier for subsequent modules and the generative AI model to interpret, together with a record that still retains the original text for reference.

### Step 5:

Server constructs a task-specific prompt sentence.

Server takes the normalized text as input and uses a prompt generation module to embed this text into a predefined instruction template. Server concatenates fixed instruction segments with the normalized text using string formatting operations. Server generates, for example, the following prompt sentence: “You are a system that extracts reservation information from user input. Extract date, time, city, venue name, number of people, and any special notes. Respond only in JSON with keys: date, time, location_city, venue_name, number_of_people, notes. User input: ‘Tomorrow at 3 μm I want to reserve a table at Restaurant A in Tokyo for two people.’” In this processing, server converts a plain normalized user text into a structured instruction that defines the task, required fields, and output format for the generative AI model. The output of this step is a prompt sentence string that will be passed to the model.

### Step 6:

Server sends the prompt sentence to the generative AI model.

Server uses an artificial intelligence communication module to transmit the prompt sentence to a generative AI model accessible via a network API. The input to this step is the prompt sentence constructed in Step 5. Server wraps the prompt sentence into a model request object, adds configuration parameters such as model identifier, maximum output length, and a temperature parameter to reduce randomness, and serializes this object into a protocol-specific request payload. Server then sends this payload as an HTTP(S) request to a model-serving endpoint. The output of this step is an outbound request that triggers execution of the transformer-based generative AI model on remote or local computational hardware.

### Step 7:

Server receives the model's textual response.

Server waits for and receives an HTTP(S) response from the generative AI model endpoint. The input to this step is the network response payload containing the model's generated text. Server decodes the payload, handles any transport- or application-level errors, and extracts the response text that purports to contain structured reservation information according to the schema requested in the prompt sentence. The output is a response string held in memory, which the server passes to subsequent parsing logic.

### Step 8:

Server parses the model output into structured reservation data.

Server provides the model's response string as input to a response parsing module. Server applies deterministic parsing rules that correspond to the schema specified in the prompt sentence. When the model output resembles key-value pairs or a structured pattern, server locates field labels such as “date,” “time,” “location_city,” “venue_name,” “number_of_people,” and “notes,” and extracts their corresponding values. Server then converts the extracted values into typed fields of an internal reservation object: for example, server parses the date string into a date type, normalizes the time into a 24-hour representation, and converts number words into integers. The processing at this step is a text-to-structure transformation that maps unstructured model text into a structured, machine-readable data object. The output is a reservation data object with populated fields and associated metadata.

### Step 9:

Server validates the structured reservation data.

Server takes the structured reservation object as input and executes a validation module on each field. Server performs format checks by using parsing routines: server verifies that the date field matches an acceptable pattern and converts it to an internal date representation; server checks that the time field can be interpreted as a valid time and lies within a permissible daily range; server ensures that the number-of-persons field is a positive integer within configured limits. Server uses mapping tables to confirm that the location and venue correspond to known entries, possibly applying string similarity matching to handle minor variations. Based on these checks, server sets validation flags for each field and records any missing or invalid items in the reservation object. The output is a validated reservation object that includes both the extracted values and validation results, such as error codes or completeness indicators.

### Step 10:

Server decides whether to refine the prompt and re-query the generative AI model.

Server inspects the validation results as input, specifically checking whether required fields are missing or invalid. If server detects deficiencies, server constructs an updated prompt sentence that explicitly asks the generative AI model to fill in the missing or correct invalid items based on the original user input. Server appends clarification instructions, for example, “The previous extraction missed some items. Provide explicit values for all keys: date, time, location_city, venue_name, number_of_people, notes. Ensure machine-readable values.” Server then uses the same communication procedure as in Step 6 to transmit the modified prompt to the generative AI model and receive a new response as described in Step 7.

Through this data-driven decision and iterative processing, server converts an incomplete or inconsistent reservation object into a more complete and consistent one. The output of this step is either a refined reservation object (if iteration is performed) or a confirmation that no further refinement is needed.

### Step 11:

Server formats validated reservation data for user confirmation.

Server uses the validated reservation object as input to a user interface formatting module.

Server converts each field—date, time, city, venue, number of people, notes—into display elements and organizes them into a standardized markup-like structure that specifies labels, values, and editability attributes. Server generates display data that clearly separates items and supports interactive editing on the terminal side. This processing transforms structured reservation data into a representation suitable for visual layout and user interaction. The output is a display data package that the server sends to the terminal via an HTTP(S) response.

### Step 12:

Terminal displays reservation details and collects user corrections.

Terminal receives the display data from the server as input and parses it to extract the reservation fields and layout instructions. Terminal renders each field on the display device as labeled, editable regions, such as text fields or dropdown lists. User reviews the displayed items and, if necessary, modifies values such as date, time, or number of people through the input device. Terminal maintains an in-memory representation of the edited reservation data. When the user confirms the reservation, terminal outputs an HTTP(S) request message carrying the confirmed or corrected reservation values back to the server.

### Step 13:

Server packages confirmed reservation data for an external reservation system.

Server receives the user-confirmed reservation data from the terminal as input. Server merges these values into the existing reservation object, overwriting earlier values as necessary, and performs a final validation pass to ensure completeness and consistency. Server then uses the reservation packaging module to map internal field names and values into the format required by an external reservation-processing system. Server constructs a transmission object that may include facility identifiers, standardized date and time fields, number of persons, and any special notes, arranged according to the external system's communication specification.

Server serializes this object into a request message and outputs it as a secure network transmission, for example, an HTTPS POST, directed to the external system's endpoint.

### Step 14:

Server receives and interprets the reservation-processing result.

Server receives a response from the external reservation-processing system as input to this step. Server decodes the response, checks the status codes, and extracts any reservation identifiers, confirmation numbers, or error codes returned by the external system. Server updates the internal reservation object with these result values and determines whether the reservation has been confirmed, rejected, or requires additional action. The output of this step is an updated reservation object that includes both the original user intent fields and the final processing status from the external system.

### Step 15:

Server generates result notification information for the user.

Server takes the updated reservation object as input and uses the user interface formatting module to create result notification data. Server constructs textual messages, such as “Your reservation is confirmed for [date] at [time] at [venue] in [city]. Reservation ID: [identifier],” using the stored fields. Server organizes this information into a compact display structure that the terminal can easily render. The output is a result notification payload, which the server transmits to the terminal in an HTTP(S) response.

### Step 16:

Terminal presents the reservation result to the user.

Terminal receives the result notification payload as input and parses the contained fields and messages. Terminal then renders a confirmation screen on the display device showing the reservation status, date, time, venue, and reservation identifier. User views this information and may optionally store it or close the interface. The output of this step is the visual presentation of the final reservation result, completing the processing flow initiated by the user's original natural-language input.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional electronic payment systems that accept natural-language input, several technical problems arise in the processing pipeline that converts a free-form user utterance into machine-executable payment instructions. First, text interpretation typically relies either on rule-based natural language processing or on a single statistical model, which is often brittle when faced with ambiguous or noisy user inputs. This leads to frequent extraction errors in key payment parameters such as date-time, amount, currency, and payee, and requires extensive post-processing logic in the application layer. As a result, the processor must perform repeated parsing and validation cycles, which increases computational overhead and latency on the server side and degrades responsiveness of the system as perceived by the user.

Second, existing systems do not efficiently combine different types of language processing engines, such as generative AI models and deterministic natural language processing libraries, in a coordinated manner. In many architectures, a generative AI model is used in an ad hoc way, without a clear mechanism to reconcile its outputs with those of a traditional parsing engine. This lack of structured integration leads to inconsistent data representations, complicates downstream processing, and causes increased consumption of computing resources due to redundant or conflicting analysis steps.

Third, when a payment instruction is converted into a request for an external electronic settlement service, known systems often construct the request data directly from partially parsed text, without generating an intermediate structured data representation subject to consistency checks. This can propagate parsing errors into external transaction calls, resulting in failed or incorrect payment attempts. Such failures not only require additional network round-trips for error handling, but also impose extra load on the processor and communication interfaces, reducing overall system throughput.

Fourth, generation of user-facing confirmation messages is often tied to rigid templates that do not adapt well to varying payment contexts or to different device capabilities. When free-form text generation is attempted, it is frequently implemented outside the core processing pipeline, as a separate application-level feature. This fragmentary design prevents the processor from reusing existing analytical context and forces the system to perform additional data transformations solely for presentation purposes, causing unnecessary duplication of computation and increased memory and bandwidth usage.

Accordingly, there is a need for a technical framework in which a processor can: (i) preprocess and normalize natural-language payment instructions in a consistent way; (ii) cooperatively employ a generative AI model and a machine-learning-based natural language processing library to obtain robust, structured settlement data; (iii) automatically verify and complete the data before constructing electronic settlement requests; and (iv) programmatically generate concise, device-appropriate notification messages using shared context. By organizing these operations as an integrated sequence of machine-level functions, the processor can reduce redundant computation, improve accuracy of extracted payment parameters, decrease the rate of failed external settlement calls, and enhance overall efficiency and reliability of the computer system.

The specific processing by the specific processing unit 290 of the data processing device 12 in Application Example 1 is realized by the following means.

The present invention provides a server comprising a processor configured to receive, via a communication interface, text data including a natural-language payment instruction from a user terminal; to preprocess the text data by performing normalization, tokenization, and removal of unnecessary information; to generate, based on a result of the preprocessing, a prompt sentence that instructs a generative AI model to extract payment-related information; to input the prompt sentence and the text data into the generative AI model to obtain candidate payment information including at least date-time information, location information, amount information, and payee information; to integrate the candidate payment information with a result of syntactic analysis and attribute extraction performed by a machine-learning-based natural language processing library; to generate structured settlement data by performing at least conversion of date expressions into a standard format, normalization of an amount and a currency, and identification and matching of a payee name; to perform consistency verification of the structured settlement data and detection of missing items, and when a missing item is detected, to transmit an additional-information input request message to the user terminal; to generate settlement request data for an external electronic settlement service based on the structured settlement data; to transmit the settlement request data to the external electronic settlement service via the communication interface using a secure communication protocol and receive settlement result data from the external electronic settlement service; and to execute, using the settlement result data and the structured settlement data as inputs, at least one of a template-based text generation process and a text generation process using the generative AI model so as to generate a text message including summary information of a settlement result and transmit the text message to the user terminal. This enables the server to implement an integrated, computer-implemented pipeline that reduces redundant parsing, improves accuracy and consistency of payment parameter extraction, lowers failure rates and retries in calls to external electronic settlement services, and generates device-appropriate confirmation messages with reduced processing and communication overhead, thereby improving the overall efficiency and reliability of the underlying computing system.

The term “text data” refers to digital data representing one or more character strings, including natural-language sentences, that are processable by a computing device.

The term “natural-language payment instruction” refers to a human-readable expression in a natural language that indicates a user's intention to perform an electronic payment, including at least one of a payee, an amount, a time, a place, or a purpose of payment.

The term “terminal” refers to an information processing apparatus, such as a mobile device, a desktop device, or a web client device, configured to transmit user input to a server and to receive and display responses from the server.

The term “processor” refers to one or more hardware processing units, such as a central processing unit or a graphics processing unit, capable of executing instructions stored in a memory to perform operations on data.

The term “preprocess” refers to performing, by the processor, one or more operations on text data, including normalization, tokenization, and removal of unnecessary information, to obtain text data in a form suitable for subsequent analysis.

The term “normalization” refers to converting text data into a canonical representation, including at least one of case folding, character set unification, whitespace unification, punctuation standardization, or expansion or contraction of specific expressions.

The term “tokenization” refers to segmenting text data into smaller units, such as words, subwords, or symbols, that can be individually processed by a language processing engine.

The term “unnecessary information” refers to portions of text data, such as stop words, extraneous punctuation, or non-essential phrases, that are determined not to contribute to extraction of payment-related information.

The term “prompt sentence” refers to a machine-readable instruction sequence including at least one natural-language expression, provided as input to a generative AI model to specify a task, constraints, or output format for the model.

The term “generative AI model” refers to a machine-learned model, such as a neural network language model, that is configured to generate or transform text data based on an input context, including at least one of prompt sentences and structured data.

The term “payment-related information” refers to information items relevant to execution of an electronic payment, including at least date-time information, location information, amount information, currency information, and payee information.

The term “candidate payment information” refers to one or more payment-related information items output by a generative AI model or another analysis engine before final validation or integration.

The term “date-time information” refers to information indicating a point in time or a time interval, including at least calendar dates, times of day, and recurring time patterns, that can be represented in a standardized time format.

The term “location information” refers to information indicating a place associated with a payment, including at least addresses, facility names, regions, or location identifiers.

The term “amount information” refers to information indicating a quantitative value to be paid, including at least a numerical value and optionally an associated currency.

The term “payee information” refers to information indicating an entity to receive a payment, including at least a person, an organization, or a merchant identifiable in an electronic settlement system.

The term “syntactic analysis” refers to analyzing a sequence of tokens to determine grammatical relationships, such as parts of speech or dependency relations, between the tokens.

The term “attribute extraction” refers to identifying and labeling specific types of information in text data, such as named entities, monetary amounts, or dates, using machine-learning-based techniques.

The term “machine-learning-based natural language processing library” refers to a software component that provides natural language processing functions implemented using one or more machine learning models, and that is executable by the processor to analyze text data.

The term “structured settlement data” refers to payment-related information represented in a defined data structure, such as a record or object, including at least a user identifier, a payee identifier, an amount, a currency type, a scheduled settlement date-time, and a settlement description.

The term “conversion of date expressions into a standard format” refers to transforming date-time information expressed in natural language into a normalized representation, such as a standardized timestamp or calendar date format.

The term “normalization of an amount and a currency” refers to converting amount information and currency information into a standardized numerical representation and a standardized currency identifier.

The term “identification and matching of a payee name” refers to determining a payee entity corresponding to a natural-language expression of a payee by comparing the expression with stored payee records, and associating the expression with a specific payee identifier.

The term “consistency verification” refers to checking, by the processor, whether structured settlement data satisfies predetermined integrity conditions, such as presence of required fields and validity of value ranges.

The term “missing item” refers to a required element of structured settlement data, such as an amount or a currency, that is absent or indeterminable based on current analysis results.

The term “additional-information input request message” refers to a message transmitted from the server to the terminal to request the user to provide one or more missing items required for settlement processing.

The term “external electronic settlement service” refers to a remote computer system that is configured to process electronic payments based on structured request data received over a communication network.

The term “settlement request data” refers to data transmitted to an external electronic settlement service, including at least a payor identifier, a payee identifier, an amount, a currency, and one or more parameters required for execution of an electronic payment.

The term “secure communication protocol” refers to a communication protocol that provides at least confidentiality and integrity for data transmitted over a network, by using cryptographic techniques such as encryption and authentication.

The term “settlement result data” refers to data received from an external electronic settlement service indicating a result of an electronic payment, including at least a status, an amount, a currency, and a settlement identifier.

The term “template-based text generation process” refers to generating a text message by inserting variable values into predefined text patterns without using a generative AI model.

The term “text generation process using the generative AI model” refers to generating or modifying a text message by applying a generative AI model to one or more inputs, including at least a prompt sentence and structured data.

The term “text message including summary information of a settlement result” refers to a message in natural language that briefly describes at least a payment status, an amount, a currency, and a payee associated with a completed or attempted settlement.

The term “notification screen of a mobile terminal or a web terminal” refers to a graphical user interface region of a terminal device configured to present alerts or messages, including settlement result notifications, to a user.

In one embodiment, a server includes at least one hardware processor, a main memory, a non-volatile storage device, and a network interface. The server executes an operating system such as a general-purpose server operating system and executes application software implemented, for example, in a high-level programming language such as Python.

The server further executes a natural language processing library and a client library for accessing an external electronic settlement service. The server also communicates, via a communication network using a secure transport protocol, with one or more terminals operated by users.

A terminal includes a display, an input interface, a wireless or wired communication module, and a control unit. The terminal executes client application software, such as a mobile application or a web browser, which transmits user input to the server and displays messages received from the server. The terminal presents to the user an input field or voice input interface for natural-language payment instructions, and a notification region for settlement result messages.

A user operates the terminal to input natural-language payment instructions. The user may type or speak sentences such as “I want to pay 3,000 yen to the gym next month” or “Pay my coffee bill at the café next Friday.” The terminal converts voice input into text by using a speech recognition engine, if needed, and transmits text data including the natural-language payment instruction to the server via the communication network.

The server receives, via the network interface, the text data from the terminal. The server stores the text data in a memory buffer and then applies preprocessing. The server performs normalization by converting all alphabetic characters to a standard case, converting full-width characters to half-width characters when appropriate, standardizing punctuation symbols, and replacing multiple whitespace characters with a single space. The server performs tokenization by invoking a tokenizer function of the natural language processing library. In one embodiment, the natural language processing library is a library that provides tokenization, part-of-speech tagging, syntactic parsing, and named-entity recognition using machine-learning models. The server removes unnecessary information by filtering out tokens that are marked as stop words in a stop word dictionary, or that match predefined patterns such as greetings or conversational fillers.

The server generates a prompt sentence for a generative AI model based on the preprocessed text and a predefined template. The server constructs the prompt sentence by inserting the preprocessed text into a template instructing the generative AI model to output payment-related information in a specific format. For example, the server generates a prompt sentence such as:

“Extract payment-related information from the following instruction. Identify date or time, merchant or payee name, amount, and currency. Return the result in a structured textual description. Instruction: ‘I want to pay for my coffee at the café next Friday.’”

In another example, the server generates a prompt sentence such as:

“From the text below, identify: (1) payment date, (2) amount, (3) currency, and (4) payee name. Explain briefly how each item was determined. Text: ‘Please pay 3,000 yen to my gym membership for next month.’”

The server transmits the prompt sentence and the preprocessed text to a generative AI model hosted either on the same server or on a remote computing resource. In one embodiment, the generative AI model is a transformer-based neural network language model including multiple self-attention layers, feed-forward layers, and layer-normalization components. The generative AI model receives tokenized representations of the prompt sentence and the preprocessed text. The model internally represents tokens as high-dimensional vectors, propagates these vectors through stacked attention blocks, and outputs a sequence of tokens representing a textual description of candidate payment information.

The server receives the textual output of the generative AI model and parses the output to obtain candidate payment information. The server uses heuristic rules, regular expressions, and shallow parsing to identify individual items in the output, such as a payment date, an amount, a currency code, and a payee name. The server stores the candidate payment information in a temporary data structure in memory.

The server, in parallel or sequentially, applies the machine-learning-based natural language processing library to the original text data or to the normalized text produced during preprocessing. The library performs part-of-speech tagging and dependency parsing by executing pre-trained statistical models, such as a convolutional neural network or a recurrent neural network, on the token sequence. The library further performs named-entity recognition to identify entities of types including monetary value, date, time, location, and organization. In addition, the server may extend the library with a custom pipeline component for recognizing domain-specific entities such as merchant names or subscription types.

The server integrates the candidate payment information obtained from the generative AI model with the entities and syntactic relations obtained from the natural language processing library. The server assigns confidence scores to each candidate item based on factors such as the presence of numeric patterns, the entity type output by the library, and the consistency with known formats. The server applies a priority rule set in which, for example, a numeric amount recognized as a monetary entity by the library overrides a textual description from the generative AI model if there is a conflict. The server also uses dependency relations, such as verb-object and modifier-head relations, to determine which amount is associated with which payee or which date applies to the payment.

The server generates structured settlement data by converting the integrated information into a predefined data structure stored as an object or record. The structured settlement data includes at least a user identifier, a payee identifier, a settlement amount, a currency type, a scheduled settlement date-time, and a settlement description. The server converts natural-language date expressions, such as “next Friday” or “next month,” into a standardized format, such as a date-time object representing a specific calendar date. The server uses a date-time library to interpret relative dates based on the current server date. The server normalizes the settlement amount and the currency by converting textual expressions like “3,000 yen” or “fifty dollars” into a numeric representation and a standardized currency code.

The server identifies and matches a payee name extracted from the text data to a payee record stored in a database. The server accesses a payee table that includes payee identifiers, canonical names, aliases, and other metadata. The server performs exact string matching and fuzzy matching, for example, by computing similarity scores between the extracted payee name and stored payee names using a string similarity algorithm. The server selects the payee record with a similarity score exceeding a threshold and stores the corresponding payee identifier in the structured settlement data.

The server performs consistency verification on the structured settlement data. The server checks that required fields are present and that values fall within acceptable ranges. For example, the server verifies that the settlement amount is greater than zero, that the currency type is one of a known set, and that the scheduled settlement date-time is not in a past period beyond a predetermined tolerance. If a required field is missing or invalid, the server determines that a missing item exists and generates an additional-information input request message.

The server transmits the additional-information input request message to the terminal via the communication network. The message may be, for example, “An amount was not found. Please enter the amount you want to pay.” The terminal displays this message to the user and provides an input area for the missing information. The user inputs the missing information, and the terminal transmits the additional information back to the server. The server updates the structured settlement data with the additional information and repeats consistency verification until the data satisfy predefined conditions.

Once the structured settlement data are consistent, the server generates settlement request data for an external electronic settlement service. The settlement request data are created by mapping the structured fields, such as user identifier, payee identifier, amount, and currency, to a format required by the external service. The server accesses a configuration that associates internal payee identifiers with external account identifiers or merchant identifiers. The server may, for example, convert an internal user identifier to a customer identifier recognized by the external service, and an internal payee identifier to a merchant account identifier.

The server transmits the settlement request data to the external electronic settlement service using the network interface. The server uses a secure communication protocol, such as a protocol employing encryption and authentication, to ensure confidentiality and integrity of the settlement request data. The external electronic settlement service processes the request and returns settlement result data, including at least a status, a transaction identifier, and the processed amount and currency.

The server receives the settlement result data and stores the data in a persistent storage device. The server then generates a text message including summary information of the settlement result. The server may perform template-based text generation by inserting values into a predefined message pattern, such as “Your payment of [amount] [currency] to [payee name] scheduled for [date] has [status].” Alternatively or additionally, the server may generate the text message using the generative AI model. In that case, the server creates a prompt sentence including the settlement result data and instructing the generative AI model to produce a concise confirmation message. For example, the server constructs a prompt sentence such as:

“Create a short confirmation message for a mobile app. The payment result is: status=succeeded, amount=3000, currency=JPY, payee name=‘fitness gym’, payment date=‘2026 Feb. 28’.”

The server transmits the prompt sentence to the generative AI model, receives the generated text, and uses the generated text as the confirmation message. The server then transmits the confirmation message to the terminal. The terminal displays the confirmation message on a notification screen or in an application interface so that the user can confirm the payment result.

The server, by coordinating the generative AI model and the natural language processing library, improves the precision and robustness of payment parameter extraction compared with systems that rely only on one type of engine. The server reduces the number of failed settlement requests by verifying and completing the structured settlement data before transmission. This architecture reduces redundant parsing operations and minimizes unnecessary network calls, thereby lowering processing load and communication bandwidth usage. The integrated use of structured settlement data for both settlement request generation and result message generation also reduces the need for additional transformation steps, which improves overall computational efficiency.

From the perspective of computer technology, the server modifies how text-processing components are orchestrated and how intermediate data structures are formed and validated. Instead of treating the generative AI model as a black box that directly outputs free-form text, the server constrains the model by specific prompt sentences and combines its outputs with deterministic syntactic and entity information. This hybrid processing reduces the model's tendency to generate inconsistent or hallucinated values and enables the processor to maintain a consistent internal representation of payment parameters. As a result, the server achieves higher extraction accuracy with fewer model invocations, which directly improves processing speed and reduces energy consumption.

In one embodiment, the generative AI model is trained using a supervised learning method on a corpus of payment-related sentences paired with structured annotations. The model parameters are updated by minimizing a loss function, such as a cross-entropy loss, using an optimization algorithm such as stochastic gradient descent with momentum or adaptive moment estimation. The training process includes data augmentation techniques, such as paraphrasing payment instructions and varying date and amount expressions, to improve generalization to unseen utterances. By training the model to respond to prompt sentences that request specific output structures, the system enables the server to obtain predictable and easily parseable outputs, reducing the complexity of downstream parsing algorithms. The natural language processing library may include multiple model variants optimized for different performance requirements. In a high-throughput scenario, the server may select a lightweight model with fewer parameters to minimize latency, while in an accuracy-critical scenario, the server may select a larger model. The server may also cache frequently used model parameters and precomputed embeddings in main memory to avoid repeated loading from storage, thereby increasing processing speed.

The server can be configured to adjust its processing pipeline based on resource constraints or network conditions. For example, when network latency to the generative AI model host is high, the server may rely more heavily on the local natural language processing library and reduce the number of calls to the generative AI model. Conversely, when complex or ambiguous utterances are detected, the server may invoke the generative AI model more frequently. Such dynamic control of processing paths constitutes a non-conventional use of computation resources and contributes to improvement of overall system efficiency.

The server, by defining an intermediate structured settlement data layer and enforcing consistency checks before external communication, improves data management and error handling. Because all settlement-related operations are based on this structured layer, the server can easily log transactions, perform audits, and analyze error patterns without reprocessing raw text. This reduces the amount of unstructured data that must be retained and simplifies maintenance of the system.

In another embodiment, the server may support multiple external electronic settlement services. In this case, the structured settlement data are mapped to different settlement request formats depending on the target service. The server can select the target service based on rules or configurations and reuse the same internal structured representation. This modular design allows the server to adapt to different external interfaces without changing the core text analysis and data integration logic.

The described system is not limited to payment instructions and can be applied to other types of transaction instructions that require extraction of structured parameters from natural-language text. However, in each case, the server uses the same technical principles: coordinated use of a generative AI model and a natural language processing library, internal structured data representation, and pre-verification before external communication. These technical features improve the functioning of the computer system as a whole, rather than merely automating a human mental process, by optimizing computational flows, reducing errors, and enhancing the reliability and efficiency of electronic transaction processing.

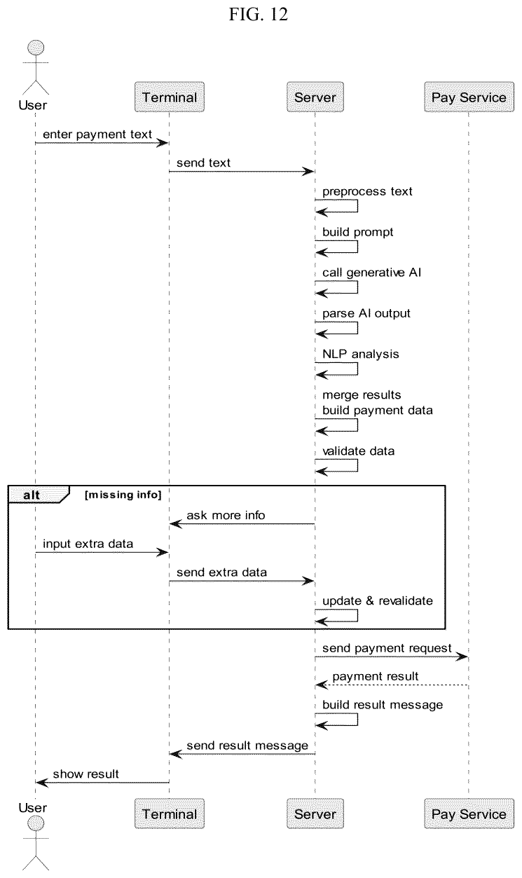

The following describes the processing flow using FIG. 12.

### Step 1:

The user inputs a natural-language payment instruction. The user types or speaks a sentence such as “I want to pay 3,000 yen to the gym next month” into the terminal's application interface. The terminal converts voice to text if necessary, and the input is stored as a text string.

Input: A raw natural-language sentence entered by the user.

Output: A text string representing the user's payment instruction stored in the terminal's memory.

### Step 2:

The terminal transmits the text string to the server. The terminal packages the text string with metadata such as a user identifier and session identifier, and sends it via a secure communication protocol to an API endpoint of the server. The terminal uses a network stack to perform connection setup, encryption, and data transfer.

Input: The text string and associated metadata in the terminal.

Output: A network message containing the text string and metadata delivered to the server.

### Step 3:

The server receives and stores the text data. The server reads the incoming network message through a network interface, extracts the text string and metadata, and writes them to a memory buffer and optionally to a log table in persistent storage. The server checks that the message format is valid and discards malformed requests.

Input: The network message containing the text string and metadata.

Output: A validated text string and metadata stored in server memory.

### Step 4:

The server preprocesses the text string. The server applies normalization by converting character cases, normalizing punctuation, and unifying whitespace; applies tokenization using a natural language processing library; and removes unnecessary information such as stop words and filler phrases. The server executes these operations as a sequence of string transformations and token-level filters.

Input: The validated text string.

Output: A sequence of normalized tokens and a cleaned text representation suitable for analysis.

### Step 5:

The server generates a prompt sentence for a generative AI model. The server inserts the cleaned text into a template that explicitly specifies what payment-related information to extract and how to format it. The server constructs, for example, a prompt such as: “Extract payment-related information (date, amount, currency, payee) from the following instruction and describe each item. Instruction: ‘I want to pay 3,000 yen to the gym next month.’” Input: The cleaned text representation.

Output: A prompt sentence combining the task description and the user's instruction.

### Step 6:

The server invokes the generative AI model with the prompt sentence. The server sends the prompt sentence to a generative AI model interface, which tokenizes the prompt, propagates token embeddings through its neural network layers, and produces a textual output describing candidate payment information. The server waits for the model response over the network or local inter-process communication.

Input: The prompt sentence.

Output: A model-generated text containing candidate payment information in descriptive form.

### Step 7:

The server parses the model-generated text into structured candidate information. The server applies pattern matching, regular expressions, and simple parsing rules to extract fields such as a candidate date, a candidate amount, a candidate currency, and a candidate payee name from the model output. The server maps these extracted values into a temporary key-value structure.

Input: The model-generated descriptive text.

Output: A set of candidate payment parameters stored as a temporary structured record.

### Step 8:

The server performs statistical natural language analysis using a machine-learning-based library. The server runs the library's pipeline on the original or normalized text, performing tokenization, part-of-speech tagging, dependency parsing, and named-entity recognition. The library uses pre-trained models to assign tags and entity labels to tokens.

Input: The original or normalized text string.

Output: A structured representation containing tokens, syntactic relations, and recognized entities such as dates, monetary amounts, and organizations.

### Step 9:

The server integrates the candidate information from the generative AI model with the entities from the natural language processing library. The server computes confidence scores for each field based on model origin, entity type, numeric consistency, and conflict rules. Using these scores and priority rules, the server selects final values for date, amount, currency, and payee.

Input: The candidate payment parameters and the library-generated entities and syntax data.

Output: A consolidated set of payment parameters with resolved conflicts and associated confidence values.

### Step 10:

The server converts natural-language date expressions into a standard date-time format. The server uses a date-time library to interpret phrases such as “next month” relative to the current date, computes the corresponding calendar date, and stores it as an ISO 8601 date-time value. The server performs arithmetic on current timestamps to calculate the final scheduled date.

Input: The consolidated date expression and the current server time.

Output: A standardized date-time value representing the scheduled settlement time.

### Step 11:

The server normalizes the amount and currency. The server parses numeric expressions from the amount text, removes formatting characters such as commas, and converts the value into a machine-usable number. The server maps currency names or symbols to standardized currency codes.

Input: The consolidated amount expression and currency expression.

Output: A numeric amount and a standardized currency code.

### Step 12:

The server identifies and matches the payee name to an internal payee record. The server compares the consolidated payee name with stored payee names using exact matching and similarity scoring, and retrieves the internal payee identifier corresponding to the best match above a threshold.

Input: The consolidated payee name and a database of payee records.

Output: A payee identifier linked to the internal data model.

### Step 13:

The server constructs structured settlement data. The server aggregates the standardized date-time, normalized amount, currency code, payee identifier, and user identifier into a settlement data object. The server adds a settlement description derived from the original text and stores this object in memory and optionally in a transaction-preparation table.

Input: The finalized payment parameters and user-related metadata.

Output: A structured settlement data object containing all fields required for settlement.

### Step 14:

The server performs consistency verification on the structured settlement data. The server checks predefined rules such as presence of mandatory fields, non-negative amounts, supported currency codes, and valid scheduled dates in the future. The server evaluates each rule and compiles a list of missing or invalid items, if any.

Input: The structured settlement data object.

Output: A verification result indicating validity and a list of detected missing or inconsistent items.

### Step 15:

The server generates an additional-information input request when needed. If verification reveals missing fields, the server constructs a human-readable message describing what is missing, such as “The payment amount is not specified. Please enter an amount.” The server sends this message to the terminal for display.

Input: The list of missing or invalid items.

Output: An additional-information request message transmitted to the terminal.

### Step 16:

The user supplies missing information through the terminal. The user reads the request message, enters data such as a missing amount or clarifies the payee, and confirms the input. The terminal sends the new data to the server as a follow-up message.

Input: The additional-information request displayed on the terminal.

Output: A user-supplied data message containing the requested information sent to the server.

### Step 17:

The server updates and re-validates the structured settlement data. The server merges the newly received data with the existing settlement data object and repeats the consistency checks. If the data now satisfy all rules, the server marks the settlement data as complete.

Input: The previous settlement data object and the user-supplied additional information.

Output: An updated, verified settlement data object ready for external settlement.

### Step 18:

The server maps the internal settlement data to settlement request data for an external service.

The server converts internal identifiers to external customer and merchant identifiers, converts the amount to the unit required by the external service, and arranges the data fields into the required request format.

Input: The verified settlement data object.

Output: A settlement request data structure formatted for the external electronic settlement service.

### Step 19:

The server transmits the settlement request data to the external electronic settlement service.

The server establishes a secure connection, serializes the request data, and sends it as a network message. The server waits for a response and handles protocol-level acknowledgments and errors.

Input: The settlement request data structure.

Output: A transmission event and, eventually, a response message from the external service.

### Step 20:

The server receives and stores the settlement result data. The server reads the response message, extracts fields such as status, transaction identifier, processed amount, and timestamp, and stores these values in a persistent transaction log or database record.

Input: The response message from the external settlement service.

Output: A settlement result data record stored in server storage.

### Step 21:

The server generates a human-readable settlement result message. The server either fills a predefined template with the result data or creates a new prompt sentence for the generative AI model that describes the settlement result and requests a concise confirmation message. For example, the server may generate: “Create a short confirmation message. Status: succeeded, amount: 3000, currency: JPY, payee: ‘fitness gym’, date: 2026 Feb. 28.”

Input: The settlement result data and the structured settlement data.

Output: A final text message that summarizes the settlement outcome.

### Step 22:

The server transmits the final text message to the terminal. The server packages the message with status and transaction identifiers and sends it via the secure communication protocol. The terminal receives the message, parses it, and displays the confirmation message on a notification or result screen for the user.

Input: The final text message and associated metadata.

Output: A displayed confirmation notification on the terminal's user interface.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional reservation processing systems that accept natural language input suffer from several technical limitations at the level of computer operation. First, when unstructured text describing a reservation request is directly supplied to a learning model or rule-based engine, the computing device frequently performs redundant parsing, error handling, and retry processing, which increases processor load and latency and leads to unstable extraction accuracy of reservation information, such as reservation dates, times, and locations. Second, many existing systems treat the natural language model as a black box and do not systematically coordinate the model output with deterministic language processing software. As a result, the systems cannot reliably validate or normalize model outputs, so that inconsistent or ambiguous reservation data must be manually corrected by the user, and the overall throughput of the reservation pipeline on the server is degraded. Third, communication between the reservation server and external processing apparatuses, such as external reservation systems, is often implemented in an ad hoc manner without end-to-end structuring of data formats and transmission procedures. This causes additional conversion steps, communication retries, and error recovery on the server, thereby consuming processing resources and increasing the time required until a final reservation result can be returned to the user terminal.

There is therefore a need for a technical architecture that improves the way a processor of a server handles natural language reservation requests, by tightly integrating preprocessing, generative model control via prompt sentences, deterministic language-processing validation, and structured communication with external processing apparatuses. Such an architecture should reduce unnecessary computation, lower the rate of extraction errors, and streamline the flow of structured reservation data through the entire pipeline. In particular, there is a need for a system in which the processor itself is configured to (i) normalize and pre-segment the input character information, (ii) construct and supply specialized prompt sentences to a generative AI model so as to obtain machine-readable reservation information, (iii) verify and normalize the extracted reservation information using language processing software, and (iv) convert and transmit the normalized reservation information and responses in formats suitable for external processing apparatuses and user terminals. By addressing these issues at the level of how the processor orchestrates text handling, model invocation, validation, and communication, the overall computer system can be improved in terms of processing efficiency, reliability, and consistency of reservation results.

The specific processing by the specific processing unit 290 of the data processing device 12 in Example 2 is realized by the following means.

The present invention provides a server comprising a processor configured to receive, from a terminal operated by a user, character information including a reservation request described in natural language; perform preprocessing on the character information, the preprocessing including at least normalization processing, segmentation processing, and removal of unnecessary components; construct a prompt sentence for analyzing the preprocessed character information and input the prompt sentence and the character information into a generative artificial intelligence model so as to cause the generative artificial intelligence model to analyze the character information and extract reservation information including at least a reservation date and time and a reservation place; verify an analysis result obtained from the generative artificial intelligence model by using language processing software and normalize the reservation information based on a verification result; convert the normalized reservation information into an information format requested by an external processing apparatus, generate transmission data, and transmit the transmission data to the external processing apparatus via a communication path; and acquire response information received from the external processing apparatus, convert the response information into character information, and transmit the character information to the terminal of the user. This enables the server to improve the internal operation of the computer system by reducing redundant parsing and error handling, by controlling the generative artificial intelligence model through structured prompt sentences to directly obtain machine-usable reservation data, by programmatically validating and normalizing the model output using deterministic language processing software within the processor, and by enforcing structured, format-consistent communication with external processing apparatuses and terminals, thereby enhancing processing efficiency, reliability, and consistency of reservation handling at the system level.

The term “system” refers to an arrangement of one or more computing devices and communication resources that cooperate to perform reservation processing based on natural language input.

The term “processor” refers to one or more hardware processing units, such as a central processing unit or a graphics processing unit, and associated control circuitry that execute instructions to perform operations on data.

The term “terminal” refers to an information processing device operated by a user, including but not limited to a portable electronic device, a stationary computing device, or any display-equipped device capable of transmitting and receiving data to and from a server.

The term “user” refers to a human operator or an organization that uses the terminal to input reservation requests in natural language and receive reservation results.

The term “character information” refers to data expressed as a sequence of symbols, letters, digits, or punctuation that can be represented in a character encoding scheme and processed by a computing device.

The term “reservation request” refers to character information that describes, in natural language, an intent to create, modify, or cancel an arrangement such as a booking, appointment, or allocation of a resource.

The term “natural language” refers to a human language commonly used for communication, such as a spoken or written language, that is not limited to a formal programming or markup language.

The term “preprocessing” refers to a series of operations performed on character information prior to analysis by a model or program, including but not limited to normalization processing, segmentation processing, and removal of unnecessary components.

The term “normalization processing” refers to converting character information into a standardized representation, including but not limited to unifying character forms, adjusting spacing, and harmonizing encoding or notation.

The term “segmentation processing” refers to dividing character information into units such as tokens, words, or segments that are suitable for subsequent analysis by software or models.

The term “removal of unnecessary components” refers to eliminating elements from the character information that are not required for extracting reservation information, such as extraneous symbols, noise text, or irrelevant phrases.

The term “prompt sentence” refers to an instruction string or message supplied to a generative artificial intelligence model, which specifies how the model should analyze input data and what type of output, including structure and content, is required.

The term “generative artificial intelligence model” refers to a trained computational model that generates output data, such as text or structured information, in response to input data and instructions, and that is capable of analyzing and transforming natural language.

The term “analysis result” refers to information output from the generative artificial intelligence model after processing character information and a prompt sentence, including extracted data items related to a reservation.

The term “reservation information” refers to structured data derived from a reservation request and including at least a reservation date and time and a reservation place, and optionally additional items such as the number of persons or type of service.

The term “reservation date and time” refers to temporal information indicating when a reservation is intended to start or occur, represented in a format that can be interpreted and processed by a computing device.

The term “reservation place” refers to spatial or location-related information indicating where a reservation is intended to be fulfilled, including but not limited to a facility, venue, or geographic area.

The term “language processing software” refers to a program or collection of programs that perform operations on natural language character information, such as tokenization, parsing, entity recognition, or consistency checking.

The term “normalize the reservation information” refers to converting extracted reservation information into a consistent and unambiguous internal representation, including standardizing date and time formats, resolving relative expressions, and mapping locations to canonical identifiers.

The term “external processing apparatus” refers to a computing system or device that is distinct from the server and that processes reservation-related data, such as an external booking system, scheduling system, or resource management system.

The term “information format requested by an external processing apparatus” refers to a specified structure, encoding, or schema for data that must be satisfied in order for the external processing apparatus to correctly interpret reservation information.

The term “transmission data” refers to data that has been formatted and packaged for transfer over a communication path from the processor to another device or system.

The term “communication path” refers to a logical or physical channel through which data is transmitted between devices, including but not limited to wired networks, wireless networks, and combinations thereof.

The term “response information” refers to data transmitted from the external processing apparatus to the server in reply to transmitted reservation information, including confirmation, rejection, modification, or error details.

The term “structured document” refers to a data representation, such as a markup document or structured text, in which information is organized according to a predefined format, schema, or hierarchy to express reservation results.

The term “request message based on a transfer control scheme” refers to a transmission unit of data, such as a request packet or protocol-level message, formatted in accordance with a communication or transfer control protocol.

The term “communication standard having an encryption function” refers to a communication protocol or specification that supports encryption of transmitted data so as to protect the confidentiality and integrity of information exchanged between devices.

In one embodiment, a server, a terminal, and a user cooperate to implement a reservation processing system that utilizes a generative AI model controlled by a prompt sentence, together with deterministic natural language processing and structured communication with external processing apparatuses.

The server operates on general-purpose computing hardware such as a rack-mounted server including at least one central processing unit (CPU), a main memory, a non-volatile storage device, a network interface, and optionally a graphics processing unit (GPU) for accelerating neural network computation. The CPU executes an operating system such as a general-purpose server operating system and an application program implementing the reservation processing logic. The GPU executes numerical computations related to a generative AI model when the model is deployed on premises. The non-volatile storage stores model parameters, configuration files, and application data. The network interface connects the server to external processing apparatuses and to terminals via a packet-switched network.

The terminal operates on hardware such as a portable information processing device or a stationary information processing device. The terminal executes a terminal-side application on an operating system such as a mobile operating system or a desktop operating system. The terminal application provides an input interface and a display interface for the user. The terminal includes a user interface module implemented with, for example, a native UI toolkit.

The terminal further includes a communication module that transmits and receives messages to and from the server over a secure communication protocol such as HTTPS, and a local storage module that stores user settings and, optionally, cached reservation information.

The user operates the terminal to input a reservation request in natural language. The user views messages presented on the display of the terminal and, as needed, provides additional or corrected information. The user may be an individual or an organization. The user does not access the generative AI model directly; instead, the server mediates all interactions and enforces the technical constraints described below.

The server stores and executes a program that implements the following functional modules: an input reception module, a text preprocessing module, a prompt construction module, a generative AI access module, a language processing validation module, a normalization module, a data mapping module, a communication control module, a response textification module, and a logging and monitoring module. These modules are realized as software components (for example, services or modules written in a general-purpose programming language) that run on the CPU and cooperate through well-defined data structures in memory and storage.

The terminal executes a corresponding client-side program that implements at least: an input acquisition module, a transmission module, a reception module, and a display module. The terminal acquires from the user a reservation request in natural language, converts the input into character information encoded in a standard character encoding (for example, UTF-8), and sends the encoded data to the server in a structured format (for example, a serialized object containing the input text and meta-information such as language or time zone). The server receives, via the input reception module, the character information from the terminal. The server stores the received character information as a record in a data structure such as a relational database table or a log file. The server uses a text preprocessing module to perform normalization processing (for example, unifying character variants, converting full-width characters to half-width characters, harmonizing line breaks), segmentation processing (for example, tokenizing text into word tokens or subword units using a tokenizer comparable to those provided by software such as spaCy or NLTK), and removal of unnecessary components (for example, removing control characters, redundant whitespace, or noise phrases that have been predetermined to be irrelevant to reservation extraction). The server maintains an internal representation of the processed text as an array or list of token objects in memory, each token object including at least an index, a surface form, and a normalized form.

The server uses a language processing validation module implemented using natural language processing software comparable to spaCy or NLTK to annotate the tokens with linguistic information. The server computes part-of-speech tags, dependency relations, and named entities such as dates, times, and locations. The server stores these annotations in memory as attributes of the token objects and as a separate list of entity objects. This deterministic processing provides an explicit feature set (for example, candidate date expressions, candidate location expressions) that the server later uses to constrain or validate the generative model output.

The server constructs a prompt sentence that instructs the generative AI model how to analyze the preprocessed character information. The server uses the prompt construction module to assemble template strings and dynamic elements derived from the preprocessed text and its annotations. In one example, the server constructs a prompt sentence in English as follows:

“You are a reservation information extractor. From the following text, extract the reservation date and time and the reservation place.

Text: ‘I want to reserve a table for dinner tomorrow at 7 PM in Tokyo.’ Return only the extracted reservation date and time and reservation place in a concise textual form”

In another example, the server constructs a prompt sentence in a different natural language as follows:

[symbol]

[symbol]

[symbol]

[symbol]

[symbol]

[symbol]

[symbol]

[symbol]

[symbol]

[symbol]

[symbol]

[symbol]

[symbol]

The server may further embed deterministic hints derived from the language processing software, for instance:

“Detected time expression: ‘tomorrow at 7 PM’. Detected location candidate: ‘Tokyo’. Confirm and refine these values using the context of the text.”

By embedding such hints into the prompt sentence, the server modifies the input space of the generative AI model and biases the model toward consistent interpretations with the deterministic analysis, which mechanically reduces the search space of possible outputs and lowers the rate of misinterpretations.

The server accesses a generative AI model via the generative AI access module. In one embodiment, the generative AI model is a transformer-based neural network deployed on the same server or on a separate computation node. The neural network includes a plurality of encoder-decoder layers or decoder-only layers, each comprising multi-head self-attention units, feed-forward networks, and normalization units. The model parameters are stored in a parameter file accessible to the GPU and main memory. The server loads the parameters at initialization and keeps them in memory for inference.

The server converts the prompt sentence and the character information into a numerical representation as follows. The server applies a tokenizer associated with the generative AI model to the concatenation of the prompt sentence and the input text. The tokenizer converts the text into a sequence of token identifiers and then to embedding vectors using a learned embedding matrix stored as part of the model parameters. These embedding vectors are then provided as input to the neural network. The generative AI model computes attention scores between tokens, propagates signals through multiple layers of linear transformations and non-linear activation functions, and outputs a sequence of token probabilities corresponding to plausible results. The server decodes the token sequence with the highest cumulative probability (or with a beam search strategy) into an output string.

The server obtains the model's output as an output string and treats this output as an analysis result that purports to represent reservation information. The server does not accept this output blindly; instead, the server passes the output through the language processing validation module and the normalization module. The server parses the output string into candidate fields, such as candidate date string and candidate location string. The server compares these candidate values with entities detected in the original preprocessed text. If the generative AI model suggests a date or place that is inconsistent with the deterministic named entities, the server uses rules encoded in the validation module to either reject the output, request a refined output from the generative AI model with a new prompt sentence, or correct the output by selecting the highest-confidence deterministic entity.

For example, if the generative AI model outputs:

“Reservation date and time: tomorrow at 9 PM

Reservation place: Tokyo”

but the deterministic named entity recognition has identified “tomorrow at 7 PM” as the only time expression, the server may generate a revised prompt sentence such as:

“The time expression in the original text is ‘tomorrow at 7 PM’. Do not introduce a different time. Extract the reservation date and time and reservation place again based only on this expression and the original context.”

By iterating this process under programmatic control on the server, the system enforces consistency between the generative AI model's flexible reasoning and the deterministic analysis. This combination leads to a reduction in extraction errors and prevents certain classes of hallucinations.

The server then normalizes the reservation information. The normalization module converts relative time expressions such as “tomorrow at 7 PM” into absolute timestamps by combining the expression with a reference time (for example, the current time at the server or a time indicated by the terminal) and a time zone identifier. The module uses a date-time library to compute a standardized representation (for example, Coordinated Universal Time) and stores the result as an integer timestamp or a structured date-time object. The server also maps textual location expressions to canonical location identifiers by consulting a mapping table stored in the database. The mapping table associates location names with internal codes that are recognized by external processing apparatuses.

The server uses a data mapping module to convert the normalized reservation information into an information format requested by an external processing apparatus. The server constructs a data structure such as a structured text document or a structured message. The data structure includes at least fields for the canonical location identifier, the standardized reservation date and time, and any other required parameters, such as the number of persons.

The server implements a schema mapping that translates internal field names to external field names and ensures that all required fields conform to the constraints (for example, type, range, and format) specified by the external apparatus.

The server uses a communication control module to package the mapped data into a request message based on a transfer control scheme, such as an application-layer protocol over a transport protocol. The server sets headers, encodes the body, and applies an encryption function according to a communication standard with an encryption function (for example, a secure transport protocol). The server transmits the request message to the external processing apparatus through the network interface. The external processing apparatus may be, for example, a reservation management server that operates its own database and scheduling logic.

The external processing apparatus processes the request and returns response information indicating, for example, whether the requested reservation is confirmed, rejected, or modified. The server receives this response information via the communication control module and decodes the message. The server then converts the structured response into character information suitable for presentation to the user. The response textification module may use a template-based generation mechanism to construct a natural-language message that summarizes the external apparatus's decision, including the confirmed date and time, the location, and any identifier assigned by the external apparatus.

For example, the server may generate the following response text:

“Your reservation for dinner on Feb. 1, 2026 at 7:00 PM at the Tokyo location has been confirmed. The reservation identifier is 12345.”

The server transmits the response text to the terminal, where the terminal's display module renders the message on the screen. The user confirms the reservation status and may optionally send a follow-up request, which repeats the above-described processing.

This architecture yields specific technical effects that go beyond mere automation of a human mental task. By combining deterministic language processing and a generative AI model under the control of structured prompt sentences, the server reduces the number of failed parses and re-requests compared with a configuration that uses only deterministic rules or only a generative model. This reduces CPU cycles, network usage, and storage of erroneous intermediate states. The use of normalized internal representations for date, time, and location reduces ambiguities and allows efficient indexing and retrieval in data storage. By enforcing schema mapping and consistent message formats, the server reduces the need for ad hoc conversion logic and simplifies the error-handling routines.

From the perspective of computer technology, the invention improves the functioning of the server by organizing text processing into explicit modules and data flows. For example, the server restricts the input to the generative AI model to preprocessed, tokenized text and a carefully constructed prompt sentence. This restriction reduces the input entropy, which empirically results in fewer computationally expensive decoding steps. Furthermore, the cross-checking mechanism between deterministic language processing and the generative AI model enables the system to detect inconsistencies early and to avoid propagating erroneous data into the external communication layer, thereby reducing downstream correction processing.

The generative AI model itself is trained, in one embodiment, using supervised learning on a corpus of reservation-related text. During training, the model receives input sequences consisting of prompt sentences and user texts, and target sequences representing correct extractions. The training process uses a loss function such as cross-entropy between the predicted token probabilities and the target tokens. The model parameters are updated via gradient-based optimization (for example, stochastic gradient descent with an adaptive optimizer). Data augmentation techniques may be applied during training, such as generating paraphrases of reservation requests or injecting synthetic noise, to improve robustness. The learned parameters encode patterns that enable the model to generalize to unseen reservation requests while remaining controllable via the prompt sentences at inference time.

The server exploits these trained parameters during inference but constrains the inference behavior using programmatic checks. For instance, when the output length or structure deviates from expectations defined in the prompt sentence, the server detects such deviations and either truncates the output, rejects the output, or reissues the prompt with additional instructions. This interplay between neural computation and rule-based enforcement constitutes a non-conventional technical arrangement that improves system robustness and reduces the demand for manual oversight.

In an alternative embodiment, the server uses a different type of generative AI model, such as a sequence-to-sequence recurrent network, a convolutional sequence model, or a mixture-of-experts architecture. In another embodiment, the language processing validation module uses a different natural language processing library or a custom rule engine. In yet another embodiment, the communication control module uses a different transfer control scheme or a different encryption standard. In each case, the overall structure is preserved: the server preprocesses text, constructs a prompt sentence, invokes a generative AI model, validates and normalizes the result, maps data to an external format, and communicates with an external processing apparatus, then generates a user-facing textual response.

The system can be adapted to different types of reservations or resource allocations by changing the mapping tables, prompt templates, and validation rules, without altering the fundamental interaction pattern between the deterministic modules and the generative AI model. As a result, the invention provides a flexible yet technically grounded framework for high-accuracy, high-efficiency reservation processing using a generative AI model controlled by structured prompt sentences and validated by deterministic language processing on a server.

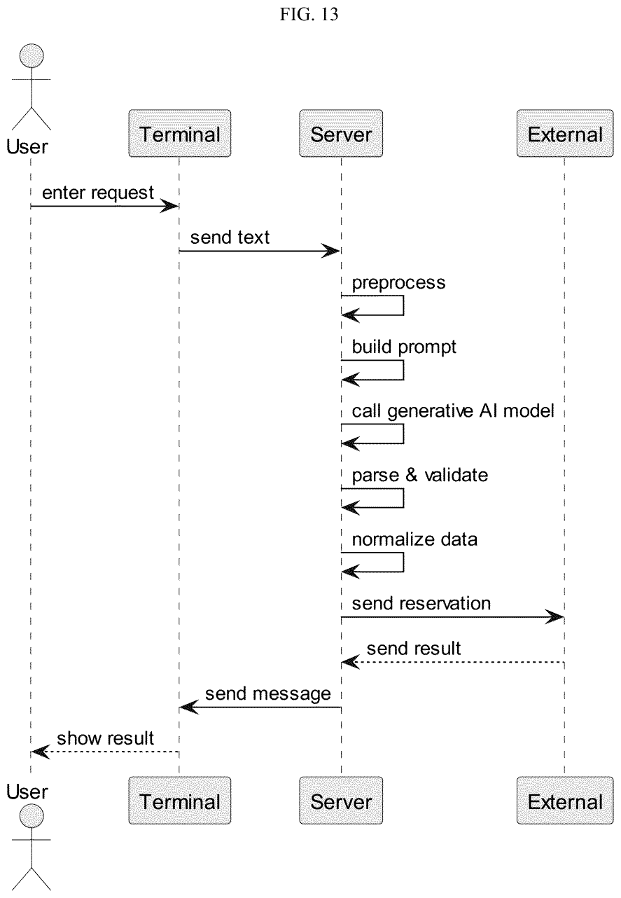

The following describes the processing flow using FIG. 13.

### Step 1:

The user operates the terminal to input a reservation request in natural language.

The user types text such as “I want to reserve a table for dinner tomorrow at 7 PM in Tokyo” into an input field provided by the terminal and presses a send button.

The input of this step is the user's keystrokes and touch events, and the output is character information encoded by the terminal (for example, a UTF-8 text string) stored in a buffer in the terminal's memory.

### Step 2:

The terminal formats and validates the character information for transmission.

The terminal checks that the input text is not empty and that a network connection is available, then creates a data object including fields such as user identifier, language code, time zone, and the input text.

The input of this step is the raw text string from Step 1, and the output is a structured data record (for example, a key-value set) that contains the text plus meta-information, ready to be serialized.

### Step 3:

The terminal serializes the structured data and transmits it to the server.

The terminal converts the structured data into a serialized representation (for example, a byte sequence) and sends it via a secure communication protocol to a designated server endpoint.

The input of this step is the structured data record from Step 2, and the output is a network message that reaches the server's communication interface.

### Step 4:

The server receives the network message and reconstructs the structured data.

The server's communication module reads the incoming bytes from a network socket, performs decryption and integrity checks, and deserializes the payload back into fields such as user identifier and input text.

The input of this step is the encrypted network message from Step 3, and the output is an internal data structure residing in the server's memory that contains the original character information and associated meta-information.

### Step 5:

The server performs text normalization on the received character information.

The server applies normalization rules to the text, such as converting character variants, trimming leading and trailing spaces, unifying line breaks, and normalizing punctuation.

The input of this step is the raw text field extracted in Step 4, and the output is a normalized text string that removes superficial variations while preserving semantic content.

### Step 6:

The server segments the normalized text and removes unnecessary components.

The server tokenizes the normalized text into tokens (words or subword units) and identifies and removes tokens that match predefined patterns of noise or irrelevant expressions.

The input of this step is the normalized text from Step 5, and the output is a cleaned token sequence and a cleaned text string composed only of tokens judged relevant for reservation extraction.

### Step 7:

The server performs deterministic language analysis on the cleaned text.

The server uses language processing software to compute linguistic features such as part-of-speech tags, syntactic dependencies, and named entities (for example, time expressions and location names), and stores these features as annotations linked to the token sequence.

The input of this step is the cleaned text from Step 6, and the output is an annotated representation that includes tokens and associated linguistic metadata, forming a structured feature set for later use.

### Step 8:

The server constructs a prompt sentence for the generative AI model based on the annotated representation.

The server selects a template and inserts dynamic elements such as the original or cleaned text and, optionally, detected time and location candidates to create a prompt sentence that instructs the model on what to extract and how to format the output.

The input of this step is the annotated representation from Step 7, and the output is a prompt sentence string, for example:

“You are a reservation information extractor. From the following text, extract the reservation date and time and the reservation place.

Text: ‘I want to reserve a table for dinner tomorrow at 7 PM in Tokyo.’ Return only the extracted reservation date and time and reservation place in a concise textual form.”

### Step 9:

The server prepares model input by combining the prompt sentence and the cleaned text.

The server concatenates the prompt sentence and the relevant text into a single sequence or a structured input format expected by the generative AI model and, if necessary, adds special markers that delimit the instruction and the user text.

The input of this step is the prompt sentence from Step 8 and the cleaned text from Step 6, and the output is a combined input string ready for tokenization by the generative AI model.

### Step 10:

The server converts the combined input string into numerical tokens for the generative AI model.

The server applies a tokenizer associated with the model to map each piece of text to a discrete token identifier and then maps these identifiers to embedding vectors using an embedding matrix stored with the model parameters.

The input of this step is the combined input string from Step 9, and the output is a sequence of embedding vectors stored in memory, representing the prompt sentence and text in a numerical form suitable for neural computation.

### Step 11:

The server executes the forward pass of the generative AI model to obtain an output sequence.

The server supplies the embedding vectors to the generative AI model, which propagates them through multiple attention and feed-forward layers to compute probability distributions over possible output tokens at each position, then selects a sequence of output tokens by decoding these distributions.

The input of this step is the sequence of embedding vectors from Step 10, and the output is a sequence of output token identifiers representing the model's proposed extraction of reservation information.

### Step 12:

The server decodes the output token identifiers into an output string.

The server maps each output token identifier back to a textual form using the model's vocabulary mapping and concatenates the resulting token texts, applying rules to remove unnecessary spaces or special markers.

The input of this step is the output token sequence from Step 11, and the output is a human-readable output string that includes candidate reservation date and time and reservation place.

### Step 13:

The server parses the output string into structured reservation information.

The server applies parsing rules or simple pattern matching to separate the output string into distinct fields, such as a date-time field and a location field, and stores the values in a reservation information structure.

The input of this step is the output string from Step 12, and the output is a preliminary structured reservation record with fields populated according to the model's extraction.

### Step 14:

The server validates the preliminary reservation record using deterministic language analysis results.

The server compares the date and place fields in the reservation record with the named entities detected in Step 7 and checks consistency rules (for example, that at least one detected time expression is used and that the location string appears in the original text).

The input of this step is the preliminary reservation record from Step 13 and the annotated representation from Step 7, and the output is either a validated reservation record or a signal that indicates an inconsistency requiring correction.

### Step 15:

The server corrects or refines the reservation information when inconsistencies are detected.

The server, upon detecting a mismatch, either replaces inconsistent fields with deterministic candidates from the annotated representation or constructs a refined prompt sentence that constrains the model, such as specifying the exact time expression to use, and re-invokes the model to re-extract the information.

The input of this step is the inconsistency signal from Step 14 and the annotated representation, and the output is an updated, corrected reservation record that satisfies the server's validation rules.

### Step 16:

The server normalizes the validated reservation date and time and reservation place.

The server converts relative time expressions to absolute timestamps using the server's reference time and time zone data, formats the timestamp into a standardized representation, and maps the textual location to a canonical location identifier using a lookup table.

The input of this step is the validated reservation record from Step 14 or Step 15, and the output is a normalized reservation record containing at least a standardized date-time value and a canonical location identifier.

### Step 17:

The server maps the normalized reservation record to an external data schema.

The server constructs an external data object by renaming fields, converting data types where necessary, and adding any required parameters so that the object matches the specification of an external processing apparatus.

The input of this step is the normalized reservation record from Step 16, and the output is a schema-compliant data object that can be transmitted to an external reservation system or similar apparatus.

### Step 18:

The server packages the schema-compliant object into a request message and transmits it to an external processing apparatus.

The server encodes the object into a message body, adds protocol headers, applies encryption according to a communication standard, and sends the message via the network interface to the external apparatus.

The input of this step is the schema-compliant object from Step 17, and the output is a transmitted request message that arrives at the external processing apparatus.

### Step 19:

The server receives response information from the external processing apparatus and reconstructs a structured response.

The server reads the incoming encrypted message, performs decryption and integrity verification, parses the message body, and extracts fields such as confirmation status, external reservation identifier, and confirmed date and time.

The input of this step is the response message from the external apparatus, and the output is a structured response record stored in the server's memory.

### Step 20:

The server generates a user-facing textual message based on the structured response and normalized reservation information.

The server inserts values such as the confirmed time, place, and reservation identifier into a text template or constructs a natural-language summary that clearly indicates the reservation result to the user.

The input of this step is the structured response record from Step 19 and the normalized reservation record from Step 16, and the output is a response text string describing the reservation outcome.

### Step 21:

The server transmits the response text to the terminal.

The server encapsulates the response text in a response object, serializes it, applies encryption, and sends it through the established communication channel back to the terminal that initiated the request.

The input of this step is the response text string from Step 20, and the output is a network message carrying the response text to the terminal.

### Step 22:

The terminal receives the response text and displays it to the user.

The terminal decodes and deserializes the message, extracts the response text, and renders the text within a user interface component, optionally updating local storage with the reservation status.

The input of this step is the network message from Step 21, and the output is a visual presentation of the reservation result on the terminal's display for the user to read.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented reservation and ordering systems that accept natural language input typically rely either on fixed rule-based parsers or on isolated machine learning models. Such systems suffer from several technical limitations. First, the systems often perform only shallow parsing of the input text and therefore fail to robustly extract structured reservation information such as time, location, target entity, and user intent when the input is noisy, ambiguous, or expressed in an unanticipated phrasing. As a result, the systems either require repeated user interaction to clarify the request or fall back to manual processing, which reduces throughput and increases latency in the overall computing pipeline.

Second, conventional systems generally do not integrate emotion information as a first-class computational signal. They typically ignore the affective content of the natural language input or treat it only as a display attribute. This prevents the systems from adjusting internal scheduling, priority management, and external communication strategies based on the user's emotional state. As a consequence, the systems cannot dynamically prioritize time-sensitive or high-stress requests at the infrastructure level, and cannot efficiently allocate limited computing and communication resources such as external API calls and telephony sessions. Third, existing architectures tend to treat conventional natural language processing components and generative AI models as alternatives rather than as cooperating modules. Many systems either rely solely on deterministic preprocessing and static models, or delegate the entire extraction to a generative AI model without validating or reconciling its output. This leads to technical problems such as unstable output formats, hallucinated data, inconsistent extraction results, and degraded reliability. In particular, when a generative AI model produces malformed or inconsistent data, the downstream components must implement ad-hoc error handling, which complicates the software stack and increases computational overhead.

Fourth, existing reservation systems often perform external communication with reservation services or telephony systems in a naive manner, for example by sending unprioritized, unverified HTTP requests. Such systems typically lack tightly integrated mechanisms for packaging structured reservation requests, enforcing secure communication procedures, performing integrity checks on transmitted data, and coordinating retransmission or failure logging based on communication results. These deficiencies lead to dropped or duplicated reservations, unclear error states, and inefficient use of network and processing resources. Accordingly, there is a need for a computer-implemented system that improves the technical functioning of reservation and ordering platforms by: (i) systematically combining conventional linguistic analysis and a generative AI model under explicit prompt control; (ii) extracting and using emotion information as a computational parameter; (iii) reconciling candidate information from deterministic parsing with structured data from the generative AI model to produce fixed reservation information; and (iv) driving external communication and notification workflows based on that fixed reservation information and priority in a secure and robust manner. Such a system should reduce parsing errors, stabilize AI output formats, improve resource allocation, and enhance end-to-end reliability and latency of the reservation pipeline at the computer system level.

The specific processing by the specific processing unit 290 of the data processing device 12 in Application Example 2 is realized by the following means.

The present invention provides a server comprising a processor configured to receive text data in a natural language from a user, perform preprocessing on the received text data including unifying character types, segmenting the text data into words, and removing unnecessary words, perform linguistic analysis on the preprocessed text data including analyzing morphemes, assigning parts of speech to phrases, and analyzing dependency relationships between phrases to extract candidate information including time information, location information, target information, and intent information, perform emotion classification on the text data to identify emotion information contained in the text data and calculate an emotion type and an emotion intensity, determine a priority of a reservation process or an order process based on the time information, the location information, the target information, and the emotion information, generate a prompt sentence for a generative information processing model, the prompt sentence instructing the generative information processing model to extract reservation information and emotion information using the preprocessed text data and the candidate information as inputs, input the prompt sentence and the text data to the generative information processing model and obtain structured data including the reservation information and the emotion information, compare the structured data with the candidate information, evaluate inconsistencies between an output of the generative information processing model and the candidate information, and integrate and fix the time information, the location information, the target information, and the emotion information to generate fixed reservation information, transmit reservation request data to an external communication processing program or an external reservation processing apparatus based on the fixed reservation information and the priority, and convert reservation result data acquired from the external communication processing program or the external reservation processing apparatus into character information and generate display data for notification to a user terminal. This enables the server to technically improve the robustness and reliability of natural language reservation processing by stabilizing the format and correctness of extracted reservation data, by using emotion-derived priority to optimize internal scheduling and external communication, and by coordinating secure, integrity-checked interactions with external systems, thereby reducing parsing failures, avoiding inconsistent AI outputs, and lowering end-to-end latency and error rates of the reservation workflow at the computing system level.

The term “text data in a natural language” refers to digital data representing characters or symbols that encode human language expressions, such as sentences or phrases, which are input by a user without requiring a predefined command syntax or fixed keyword format.

The term “preprocessing” refers to a sequence of programmatic operations applied to received text data to normalize and clean the data for subsequent analysis, including at least unifying character types, segmenting the text data into words or tokens, and removing words or symbols that are determined to be unnecessary for extraction of reservation information.

The term “unifying character types” refers to converting different but equivalent character representations into a common representation, such as converting full-width characters to half-width characters, normalizing different forms of the same punctuation mark, and standardizing case where appropriate for the language.

The term “segmenting the text data into words” refers to dividing a sequence of characters into discrete units such as words, subwords, or tokens by using a lexical or statistical algorithm, in order to facilitate subsequent linguistic analysis.

The term “removing unnecessary words” refers to deleting, masking, or ignoring words, symbols, or tokens that are determined not to contribute meaningfully to reservation information or emotion information, such as stopwords, control characters, or repetitive filler expressions.

The term “linguistic analysis” refers to computational processing that extracts structural and semantic features from text data, including at least morpheme analysis, part-of-speech assignment, and dependency analysis, to identify and classify components of the text relevant to reservation information.

The term “analyzing morphemes” refers to dividing text data into the smallest meaningful linguistic units and classifying those units according to their lexical properties using a morphological analyzer or equivalent algorithm.

The term “assigning parts of speech to phrases” refers to labeling words or groups of words within the text data with grammatical categories, such as noun, verb, adjective, or adverb, to support identification of functional roles within the sentence.

The term “analyzing dependency relationships between phrases” refers to determining directed syntactic relations between words or phrases, such as subject-verb or modifier-head relations, using a dependency parser or equivalent algorithm, in order to infer how elements of the text are related to each other.

The term “candidate information” refers to intermediate information elements extracted from the text data by deterministic or statistical linguistic analysis, including at least time information, location information, target information, and intent information, prior to final confirmation as fixed reservation information.

The term “time information” refers to data elements that represent temporal aspects of a reservation or order, including explicit or implicit expressions of dates, times, time ranges, or relative temporal references such as “tomorrow” or “this evening.”

The term “location information” refers to data elements that represent spatial or geographic aspects of a reservation or order, including addresses, area names, facility names interpreted as places, or identifiers linked to locations.

The term “target information” refers to data elements that represent an object or subject of the reservation or order, such as an item to be delivered, an establishment to be reserved, or a resource to be scheduled.

The term “intent information” refers to data elements that represent a user's underlying action request or goal inferred from the text data, such as a request for delivery, a request for a table reservation, or a request for a payment option.

The term “emotion classification” refers to computational processing that analyzes text data to identify emotional attributes, such as emotional categories and degrees of intensity, using a classifier, model, or rule set trained or designed for emotion detection.

The term “emotion information” refers to information indicating an emotional state inferred from the text data, including at least an emotion type and optionally an emotion intensity, which can be used by a processor as a parameter for prioritization or adjustment of reservation processing.

The term “emotion type” refers to a label or category that characterizes a detected emotional state, such as calmness, fatigue, urgency, frustration, or desire to save money. The term “emotion intensity” refers to a quantitative or ordinal measure associated with an emotion type that indicates the strength or degree of the detected emotional state. The term “priority of a reservation process or an order process” refers to a value or ranking that represents the relative importance or urgency assigned by the processor to a specific reservation or order task, the value or ranking being used to schedule or order execution of tasks within the system or towards external systems.

The term “generative information processing model” refers to a machine-executable model that has been trained using data to generate or transform text or structured information in response to input and instructions, such as a generative AI model that can interpret prompt sentences and output structured representations of reservation information and emotion information.

The term “prompt sentence” refers to a control string or sequence of instructions provided as input to a generative information processing model, the control string specifying a task to be performed by the model and a desired output format, and optionally including context information and example structures.

The term “structured data” refers to data organized in a defined format, such as key-value pairs, records, or hierarchical objects, which represent reservation information and emotion information in a machine-readable and machine-validated form suitable for further processing.

The term “fixed reservation information” refers to reservation-related information that has been determined by the processor as final, after comparison and reconciliation of candidate information obtained from deterministic linguistic analysis with structured data received from the generative information processing model.

The term “reservation request data” refers to data derived from fixed reservation information and priority that is formatted for transmission to an external system in order to request execution of a reservation or an order.

The term “external communication processing program” refers to a program or service executed outside the server, which performs communication operations such as phone calls, messaging, or protocol-specific interactions to carry out or assist in reservations or orders.

The term “external reservation processing apparatus” refers to an external computing device or system that receives reservation request data and performs reservation-related processing, such as booking a table, scheduling a delivery slot, or confirming availability of resources.

The term “reservation result data” refers to data indicating the outcome of processing performed by an external communication processing program or an external reservation processing apparatus in response to reservation request data, including success, failure, confirmed parameters, or error information.

The term “character information” refers to textual data represented as a sequence of characters suitable for display to a user or for further processing by text-based components.

The term “display data” refers to data formatted or arranged so that a user terminal can present the data on a user interface, including layout, labels, and content derived from reservation result data and fixed reservation information.

The term “user terminal” refers to an electronic device operated by a user, such as a portable terminal, a stationary terminal, or another computing device, that can send text data to the server and display notification and result information received from the server.

The term “structured document format” refers to a markup or document representation that organizes information into an explicit schema, such as a hierarchical or tag-based structure, to enable consistent rendering and processing on the user terminal.

The term “communication request message” refers to a formatted message that encapsulates reservation request data for transmission to an external reservation processing apparatus, following a specified communication protocol.

The term “secure communication procedure” refers to a communication protocol or mechanism that provides at least integrity protection and confidentiality for transmitted data, such as an encrypted and authenticated transport session.

The term “integrity check information” refers to data, such as a checksum, hash value, or message authentication code, that is calculated from transmission data and appended to a message so that the receiving side can verify whether the data has been altered during transmission.

The term “retransmission control” refers to processing in which the processor determines, based on a communication result or detected error, whether to resend a communication request message and how many times or under which conditions to resubmit the message.

The term “failure logging” refers to storing, in a storage device, information describing an error condition or communication failure, including context such as timestamps, identifiers, and error codes, so that the error condition can be analyzed or corrected later.

In one embodiment for implementing the invention, a server, one or more terminals, and one or more external reservation processing apparatuses are interconnected through a communication network such as the Internet. The server executes a plurality of software modules on computer hardware including at least one processor, a main memory, a non-volatile storage device, and a network interface. The terminal executes a user interface program on hardware such as a portable electronic device or a stationary computing device. The external reservation processing apparatus executes a communication processing program on independent computing hardware capable of interacting with telephony interfaces or reservation backends.

Server executes an operating system such as a general-purpose server operating system and runs an application stack including a web server component, an application framework component, and multiple language-processing components. Server can execute the language-processing components as processes or services written in a high-level programming language. Server can integrate a natural language processing library such as a general-purpose tokenization and parsing library, a dependency parsing library, and a named entity recognition library. Server can also host or access a generative AI model as a generative information processing model that receives a prompt sentence and text data and outputs structured data. Server can communicate with an external emotion classification service or can execute a local emotion classification model as a trained machine learning model. Terminal presents user interface elements such as text input fields, confirmation screens, and result display screens. Terminal sends natural-language text data to server and receives display data from server. Terminal can be implemented as a mobile application or as a browser-based client that communicates with server using a communication protocol such as HTTPS. User operates the terminal to input free-form text in a natural language, such as “Tomorrow at 6 p.m. please deliver pizza to my home” or “I am very tired and want to eat early.”

Server uses a text preprocessing module to normalize the received text data. Server unifies character types by converting different encodings to a canonical form, normalizing punctuation, and standardizing whitespace. Server then segments the normalized text into tokens using a tokenization algorithm that considers language-specific rules and statistical models. Server removes unnecessary words such as high-frequency function words that are not expected to carry reservation information or emotion information, while preserving tokens that represent time, location, items, and affective expressions. Server stores the preprocessed representation in an internal data structure, such as a sequence of token objects each storing token text, position, and preliminary tags.

Server uses a linguistic analysis module to perform morpheme analysis, part-of-speech tagging, and dependency parsing. Server can use a statistical dependency parser that represents each sentence as a dependency tree, where nodes correspond to tokens and edges correspond to syntactic relations. Server identifies candidate time expressions, location expressions, target expressions, and intent expressions by traversing the dependency tree and applying pattern rules and statistical scores. For example, server identifies a token sequence that matches a temporal pattern and attaches it to a time information field. Server identifies a token sequence that represents a region or facility and attaches it to a location information field. Server uses these operations to construct candidate information as a structured object.

Server uses an emotion classification module to determine emotion information from the original or preprocessed text. Server uses features such as token n-grams, dependency relations, and lexicon-based features representing affective words. In one embodiment, server uses a neural network classifier constructed as a multi-layer architecture. The architecture can be a transformer-type network in which an embedding layer maps tokens to dense vectors, a plurality of self-attention layers compute contextualized token representations, and a classification head maps a pooled representation to an emotion type and an emotion intensity.

Server trains this classifier in advance using supervised learning with labeled data that associate text segments with emotion categories and intensity scores. Server uses a loss function such as cross-entropy for emotion type prediction and a regression loss for intensity prediction. Server updates model parameters using an optimization algorithm such as stochastic gradient descent with adaptive learning rate. Server may perform data augmentation during training by paraphrasing input text or perturbing tokens to increase robustness to input variation.

Server integrates output from the linguistic analysis module and the emotion classification module. Server creates a data object that includes at least candidate time information, location information, target information, intent information, and emotion information (emotion type and emotion intensity). Server uses this information to compute a priority value for the reservation process or order process. Server can compute the priority as a numeric score based on a rule set, for example by mapping emotion types such as “tired” or “urgent” and intensities to higher priority scores and combining them with factors such as requested time proximity. Server stores the priority together with candidate information.

Server uses a prompt generation module to generate a prompt sentence for a generative AI model functioning as a generative information processing model. Server constructs the prompt sentence to explicitly instruct the generative AI model to extract reservation information and emotion information and to return the output in a precise and constrained format. For example, server can generate a prompt sentence such as:
“Task: You are a reservation information extractor for a reservation and delivery system.
User message: [symbol] 6 [symbol] [symbol] [symbol]
Using the user message, extract the reservation date and time, the delivery location, and the ordered item. Also determine the user's emotion if it is expressed.
Return the following fields in plain text, separated by line breaks:
Reservation date and time:
Delivery location:
Item:
Emotion:”

Server includes in the prompt sentence specific instructions such as which fields to output, how to present them, and what to do in case certain information is missing. Server can further embed contextual information such as the user's default time zone, locale, or historical preferences into the prompt sentence to guide interpretation.

Server uses a generative AI interface module to send the prompt sentence and the user text data to the generative AI model. In one embodiment, server accesses the generative AI model through a network API. In another embodiment, server hosts the generative AI model locally. The generative AI model can be implemented as a transformer-based sequence model with an encoder-decoder architecture or an auto-regressive decoder-only architecture. The model can consist of multiple layers of self-attention submodules, feed-forward submodules, normalization layers, and residual connections. The model receives as input a token sequence representation of the prompt sentence plus the user text and generates as output a token sequence representing the requested fields.

Server configures model parameters such as temperature and output length to minimize stochastic variation and to favor deterministic extraction. Server obtains the output text from the generative AI model and parses the text according to the predefined format expressed in the prompt sentence. Server converts the output into structured data that contains at least a reservation date and time value, a location value, an item value, and an emotion label if available. Server uses parsing routines that check for markers or line prefixes such as “Reservation date and time:” to extract field contents and to detect malformed responses. Server uses a reconciliation module to compare the structured data obtained from the generative AI model with the candidate information previously extracted using deterministic linguistic analysis. Server applies non-trivial rules that differ from simple human manual checking. Server can apply confidence scoring to each field from each source, for example using internal confidence values from the linguistic analysis module and heuristics for generative AI consistency. Server may assign higher weight to fields where both sources agree and may trust deterministic extraction for numeric or exact patterns such as calendar dates, while using generative extraction for ambiguous phrasing or multi-step inference. Server calculates a discrepancy metric and logs cases in which the generative AI output conflicts with deterministic candidate information beyond a threshold. Server then integrates the preferred values and generates fixed reservation information that is used as the authoritative data for downstream processing.

Server uses a scheduling and communication module to generate reservation request data from the fixed reservation information and the computed priority. Server can package the data into a communication request message containing fields such as user identifier, target entity identifier, reservation time, location identifier, and priority value. Server transmits this communication request message to an external reservation processing apparatus or an external communication processing program using a secure communication procedure, such as an encrypted and authenticated transport session. Server generates integrity check information such as a hash or message authentication code from the message payload and attaches it to the message to allow the receiving side to verify data integrity. Server receives a reservation result or intermediate status from the external reservation processing apparatus. In one variant, the external reservation processing apparatus interacts with telephony hardware to place a real-time call to a facility. In this variant, the external reservation processing apparatus may use a text-to-speech engine to convert the fixed reservation information into synthesized speech and communicate with a human operator at the facility, then use a speech recognition engine to convert the response back into text that becomes part of the reservation result data. Because the external apparatus converts between textual data and audio telephony signals, the overall system is coupled to real-world communication devices and not limited to abstract data manipulation.

Server receives reservation result data including success or failure and possibly confirmed parameters such as an adjusted reservation time or assigned location. Server converts the reservation result data into character information for display. Server can map error codes or technical states into user-readable explanations such as “Reservation confirmed for 18:00” or “Requested time is full; reservation confirmed for 18:30 instead.” Server creates display data that includes textual content and optional structured attributes that guide how terminal renders the information.

Server sends the display data to terminal. Terminal renders the data in user interface components such as pop-up dialogs, notification banners, or detailed reservation screens. Terminal can also store portions of the display data in local memory for later reference by the user. User can visually confirm the reservation result or order status without needing to interpret internal technical details.

The described architecture improves computer technology for several reasons. Server avoids delegating all extraction to a generative AI model without control; instead, server coordinates deterministic linguistic analysis, emotion classification, prompt-guided generative extraction, and reconciliation through explicit modules and data structures. This hybrid approach reduces the incidence of malformed or hallucinated outputs from the generative AI model, because server constrains the model with precise prompt sentences and validates its responses against candidate information. This improves accuracy and stability of information extraction relative to systems that rely only on rules or only on an unconstrained AI model.

Server reduces system latency and network load by deriving priorities from emotion information and candidate reservation parameters. Server can schedule external communication tasks so that urgent requests are processed earlier and non-urgent requests can be batched or deferred. This scheduling reduces peak load on external communication channels and reservation backends and thereby lowers the probability of timeouts and resource contention. Server can also reduce unnecessary retries by using integrity check information and clear error classification to distinguish between transient network failures and permanent reservation failures.

Server implements specific, non-conventional algorithms for prompt generation and reconciliation that differ from typical human operations. Human operators usually read a message once and manually infer reservation information. In contrast, server constructs structured prompt sentences that explicitly request field-wise output, uses an AI model architecture trained with token-level attention mechanisms and fixed decoding parameters, and then performs systematic comparison between two independently derived signals (deterministic candidate information and generative AI output). This multi-path processing and inconsistency evaluation are adapted to the strengths and weaknesses of machine learning models and are not inherent in human cognition. As a result, the system attains lower error dispersion and a more predictable quality of extraction, which is a technical effect at the data processing level.

Server also improves data management by representing intermediate and final reservation information as structured objects with well-defined fields and identifiers. This uniform representation allows server to apply schema-based validation, caching strategies, and reuse of partially processed data. For example, server can cache tokenized text and candidate information so that if the generative AI model needs to be re-invoked with an updated prompt sentence, server can avoid re-running expensive preprocessing and linguistic analysis. This caching strategy reduces processor usage and total processing time.

In another embodiment, server can host the generative AI model and the emotion classifier locally as separate modules sharing a common embedding layer. In this embodiment, server executes a neural network architecture in which an embedding network maps tokens to vectors, a shared transformer backbone provides contextual representations, and separate heads produce outputs for reservation field extraction and emotion classification. Server trains these heads using a multi-task learning objective combining cross-entropy losses for classification tasks and sequence-to-sequence losses for extraction tasks. This multi-task configuration reduces model size and inference time, providing an improvement in computation efficiency and energy usage compared to independently executing multiple large models.

In a further embodiment, server can adjust prompt sentences dynamically based on feedback from the reconciliation module. If server detects repeated inconsistencies for a certain pattern of user messages, server can update the prompt sentence to include additional instructions or examples guiding the generative AI model to handle that pattern more reliably. Server can, for example, change the prompt sentence to:

“Example:
User message: [symbol] [symbol] [symbol] [symbol]
Correct output:
Reservation date and time: 2023 Oct. 20 18:00
Delivery location: [symbol]
Item: [symbol]
Emotion: [symbol]
Now process the following user message in the same format:
User message:

[symbol]

[symbol]

[symbol]

[symbol]

By embedding specific examples, server shapes the generative AI model's behavior in a way that refines extraction decisions. This dynamic prompt adjustment module uses machine statistics from logs and correction records to improve the behavior of the generative subsystem without retraining the underlying model, which yields an iterative optimization of system performance at runtime.

In yet another embodiment, server may alter the reconciliation strategy depending on context. For instances where the external reservation processing apparatus performs telephony with variable response quality, server may rely more heavily on deterministic parsing of AI output and strong validation rules, whereas in contexts where external systems are purely digital and highly structured, server may accept a broader range of AI-extracted parameters. This adaptivity reduces errors due to mismatches between assumed external behavior and actual external behavior, and thus better controls the end-to-end state of reservations.

In summary, server, terminal, and external apparatus cooperate in a configuration in which terminal mediates user interaction and server performs advanced computational processing that unifies deterministic linguistic analysis, emotion-aware prioritization, prompt-based generative extraction, and integrity-checked communication. The particular combination of modules, data structures, generative AI model usage with explicit prompt sentences, and reconciliation logic improves the quality, speed, and reliability of reservation-related computation beyond simple automation of human tasks and provides concrete technical effects in computer resource management, network communication stability, and data processing accuracy.

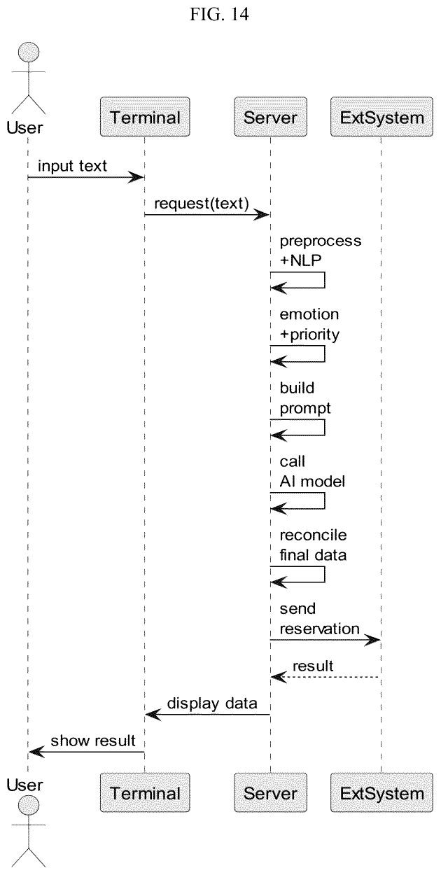

The following describes the processing flow using FIG. 14.

### Step 1:

User operates the terminal to input text data in a natural language.

User opens an application on the terminal and types a free-form sentence, for example,

“Tomorrow at 6 p.m. please deliver pizza to Shinjuku; I am very tired and want it as soon as possible.”

Terminal receives the input text as a character string and displays it in an input field for confirmation.

Terminal sets the input text, a user identifier, a language code, and a timestamp as fields in a request object.

Terminal outputs this request object and sends it to the server using a network protocol such as HTTPS.

The input of Step 1 is raw natural-language text entered by the user, and the output of Step 1 is a structured request object containing at least the text string and user-related metadata.

### Step 2:

Server receives the request object from the terminal and validates it.

Server parses the incoming HTTP request and extracts the text field, the user identifier, the language code, and any session token.

Server checks authentication by validating the session token against a session store; if the token is invalid, server rejects the request.

Server writes a log entry containing a hash of the text, the user identifier, and the reception time.

Server stores the raw text in a buffer and passes it, together with the language code, to a preprocessing module.

The input of Step 2 is the structured request object from the terminal, and the output of Step 2 is a tuple including the validated raw text and associated metadata prepared for text preprocessing.

### Step 3:

Server performs text preprocessing on the validated raw text.

Server executes a normalization routine that unifies character types by converting full-width characters to half-width, normalizing punctuation, and standardizing whitespace.

Server applies a tokenizer appropriate for the language to segment the normalized text into tokens, each token having token text and position indices.

Server evaluates each token against a stopword list and removes tokens that match high-frequency function words not necessary for reservation or emotion extraction, while preserving tokens representing time, location, items, or affective expressions.

Server constructs a preprocessed data structure, such as an array of token objects with attributes for token text, normalized form, and initial category flags.

The input of Step 3 is the raw text and language metadata from Step 2, and the output of Step 3 is a preprocessed token sequence with reduced noise and standardized token representations, ready for linguistic analysis.

### Step 4:

Server executes linguistic analysis on the preprocessed token sequence.

Server applies a morpheme analyzer to assign base forms and morphological tags to each token.

Server uses a part-of-speech tagger to assign grammatical categories such as noun, verb, adjective, and adverb to tokens.

Server constructs a dependency tree by applying a dependency parser that determines syntactic head-dependent relations between tokens.

Server traverses the dependency tree and pattern-matches sequences to extract candidate time expressions, candidate location expressions, candidate target expressions, and candidate intent expressions.

Server stores these candidate fields in a candidate information object that includes lists or sub-objects for time information, location information, target information, and intent information.

The input of Step 4 is the preprocessed token sequence from Step 3, and the output of Step 4 is a candidate information object representing structural and semantic elements identified by deterministic linguistic analysis.

### Step 5:

Server performs emotion classification based on the original or preprocessed text.

Server converts tokens into embedding vectors using a token embedding table.

Server feeds the sequence of embedding vectors into a neural network classifier, for example a transformer network with multiple self-attention layers and a classification head.

Server computes a pooled representation of the sentence, applies the classification head, and obtains a probability distribution over pre-defined emotion types such as “calm,” “tired,” “urgent,” or “wants_to_save_money.”

Server calculates an emotion intensity value, for example by mapping the maximum probability or a continuous output from the classifier to a normalized score.

Server creates an emotion information object that contains at least one emotion type label and an intensity value.

The input of Step 5 is the text representation from Step 3 or Step 2, and the output of Step 5 is emotion information comprising an emotion type and an emotion intensity suitable for use as a processing parameter.

### Step 6:

Server computes a priority for the reservation or order process based on candidate information and emotion information.

Server applies a priority function that uses factors such as time proximity, urgency words, and emotion intensity.

Server may assign a base score for expressions like “as soon as possible” and increase the score according to emotion types such as “tired” or “urgent.”

Server combines these factors, for example through a weighted sum or rule-based mapping, to compute a numeric priority value.

Server packages the candidate information, the emotion information, and the computed priority into an intermediate reservation context object.

The input of Step 6 is the candidate information from Step 4 and the emotion information from Step 5, and the output of Step 6 is a reservation context object that includes a calculated priority value.

### Step 7:

Server generates a prompt sentence for a generative AI model using the reservation context.

Server inspects which candidate fields are present or ambiguous, for example checking whether time, location, and target candidates are non-empty.

Server constructs a prompt template that specifies required output fields and output format in plain text, and then fills in the user text and relevant context such as locale or default time zone.

Server generates, for example, the following prompt sentence:

“Task: You are a reservation information extractor for a reservation and delivery system.
User message: ‘Tomorrow at 6 p.m. please deliver pizza to Shinjuku; I am very tired.’

Using the user message, extract the reservation date and time, the delivery location, the ordered item, and the user's emotion.
Return the following fields in plain text, each on its own line:
Reservation date and time:
Delivery location:
Item:
Emotion:”
Server attaches this prompt sentence and the original user message to a generative AI request object.

The input of Step 7 is the reservation context object and the original text, and the output of Step 7 is a generative AI request object containing a fully constructed prompt sentence and associated parameters.

### Step 8:

Server sends the generative AI request object to the generative AI model and obtains output text.

Server encodes the prompt sentence and the user text into input tokens using a tokenizer compatible with the generative AI model.

Server transmits the encoded sequence and model parameters such as temperature, top-p, and maximum output length to the generative AI model via an API or direct model call.

Server performs an inference pass in the generative AI model, which computes attention scores, propagates activations through multiple layers, and generates output tokens one by one until an end-of-sequence condition is met.

Server decodes the output tokens into text and obtains a model response that is expected to list each requested field on a separate line.

Server splits the response text by line breaks and parses each line to extract the values of “Reservation date and time,” “Delivery location,” “Item,” and “Emotion.”

Server stores these values in a structured AI output object.

The input of Step 8 is the generative AI request object from Step 7, and the output of Step 8 is a structured AI output object containing reservation information and emotion information as interpreted by the generative AI model.

### Step 9:

Server reconciles the structured AI output with the previously obtained candidate information to create fixed reservation information.

Server compares each field from the AI output object with the corresponding candidate field from the candidate information object.

Server calculates a confidence score for each candidate field, for example based on pattern matching strength and parser scores, and assigns a separate confidence score to each AI output field based on formatting consistency and semantic plausibility checks.

Server applies decision rules, such as selecting the value with the higher confidence score or favoring exact-date formats from deterministic parsing over relative expressions from AI output.

Server resolves conflicts, fills missing fields, and corrects inconsistent formats by applying normalization routines, for example converting “tomorrow at 6 p.m.” into a specific date-time string.

Server aggregates the chosen values into a fixed reservation information object containing finalized time information, location information, target information, and emotion information.

The input of Step 9 is the candidate information from Step 4 and the AI output object from Step 8, and the output of Step 9 is a fixed reservation information object that has been reconciled and normalized.

### Step 10:

Server generates reservation request data and prepares it for transmission to an external reservation processing apparatus.

Server maps the location information to an internal location identifier or facility identifier using a mapping table or a geocoding database.

Server maps the target information, such as “pizza,” to internal item or service identifiers used by downstream systems.

Server compiles a reservation request object containing the fixed reservation time, mapped location identifier, mapped item identifier, user identifier, and the priority value from Step 6. Server serializes this reservation request object into a communication request message, such as a JSON or binary message, and computes integrity check information such as a checksum or message authentication code.

Server appends the integrity check information to the communication request message.

The input of Step 10 is the fixed reservation information and priority from Steps 9 and 6, and the output of Step 10 is a fully prepared communication request message ready for secure transmission.

### Step 11:

Server transmits the communication request message to the external reservation processing apparatus and manages communication reliability.

Server sets up a secure communication session using a secure protocol to encrypt and authenticate the message.

Server sends the communication request message, including integrity check information, to a designated endpoint of the external reservation processing apparatus.

Server waits for an acknowledgment or response; if a timeout or error code is received, server evaluates whether to perform retransmission according to retransmission policies.

Server logs successful transmissions and records failed attempts together with error details for later failure analysis.

The input of Step 11 is the communication request message from Step 10, and the output of Step 11 is a communication result status that indicates success, failure, or intermediate states.

### Step 12:

Server receives reservation result data from the external reservation processing apparatus.

Server parses the received message and verifies the integrity check information by recomputing the checksum or message authentication code and comparing it with the attached value.

Server extracts reservation result fields, such as success or failure status, confirmed reservation time, assigned location or resource identifiers, and optional explanatory messages.

Server updates internal reservation records keyed by user identifier using the new result data.

Server creates a reservation result object that aggregates the essential fields to be conveyed to the user.

The input of Step 12 is a message from the external reservation processing apparatus, and the output of Step 12 is a reservation result object that has passed integrity verification and is stored in the server.

### Step 13:

Server converts the reservation result object and the fixed reservation information into display data suitable for the terminal.

Server formats the reservation time into a user-friendly string according to the user's locale and time zone.

Server selects or generates explanatory text describing the outcome, for example “Your reservation is confirmed for tomorrow at 6 p.m. in Shinjuku, pizza for two people.” Server assembles these textual elements into a display data structure that may also include field labels, icons, or layout hints understood by the terminal interface.

Server sends the display data to the terminal as a response payload over the network.

The input of Step 13 is the reservation result object and the fixed reservation information from Steps 12 and 9, and the output of Step 13 is fully constructed display data transmitted to the terminal.

### Step 14:

Terminal receives the display data from the server and renders it on a user interface.

Terminal parses the display data and maps it to visual components, such as title text, detail text, and status indicators.

Terminal updates the screen to show the reservation details, emotion-based priority indicators if applicable, and any error or success icons.

Terminal may store parts of the display data in local storage to build a reservation history view.

User observes the displayed information and can confirm that the system has completed the reservation or order according to the original natural-language request.

The input of Step 14 is the display data from Step 13, and the output of Step 14 is a rendered user interface state on the terminal and optional local storage of the reservation information.

### Step 15:

Server optionally logs performance metrics and adjusts prompt sentences or internal parameters for future processing.

Server records timings for preprocessing, linguistic analysis, emotion classification, generative AI inference, reconciliation, and external communication.

Server analyzes error cases where reconciliation detected frequent inconsistencies between candidate information and AI output, and identifies patterns in user messages associated with those inconsistencies.

Server updates prompt sentence templates, for example by adding clarifying instructions or concrete examples, to reduce future ambiguities for similar inputs.

Server may adjust weighting factors in the priority computation or reconciliation rules to reflect observed system behavior and performance.

The input of Step 15 is internal logs and processing results accumulated from Steps 3 through 13, and the output of Step 15 is updated configuration data, such as refined prompt sentence templates and tuned rule parameters, which improve subsequent executions of the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

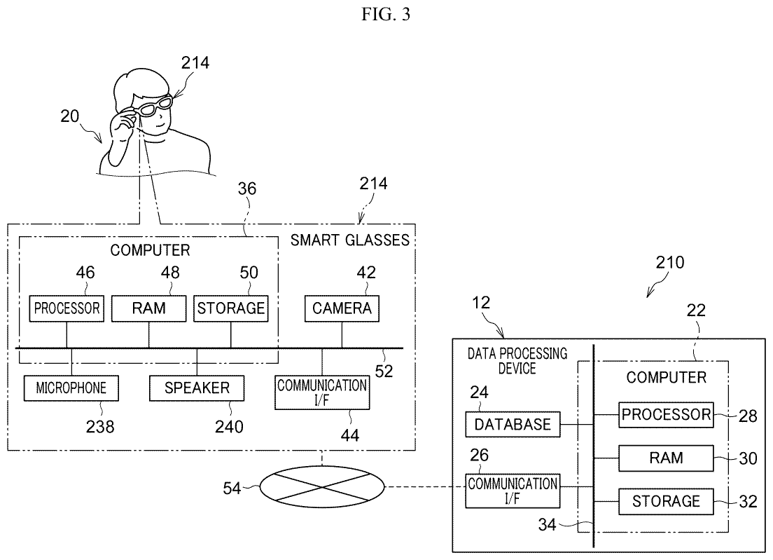

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

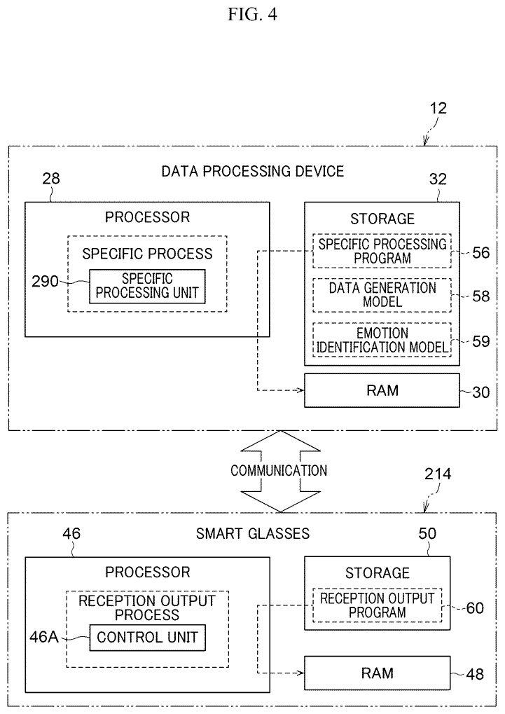

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

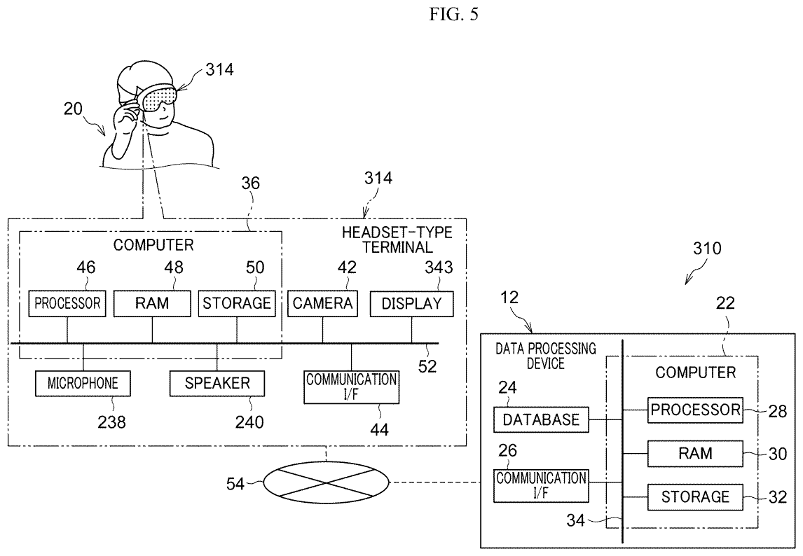

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

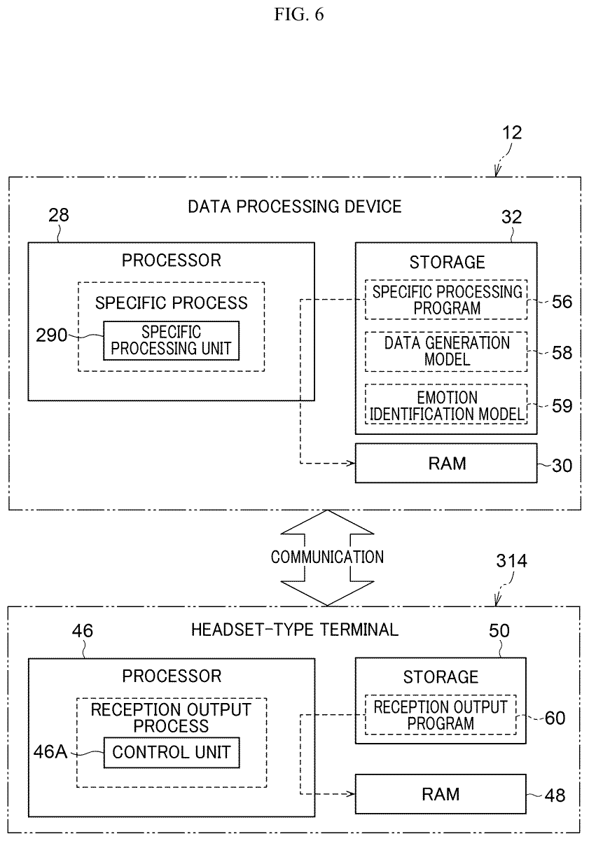

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

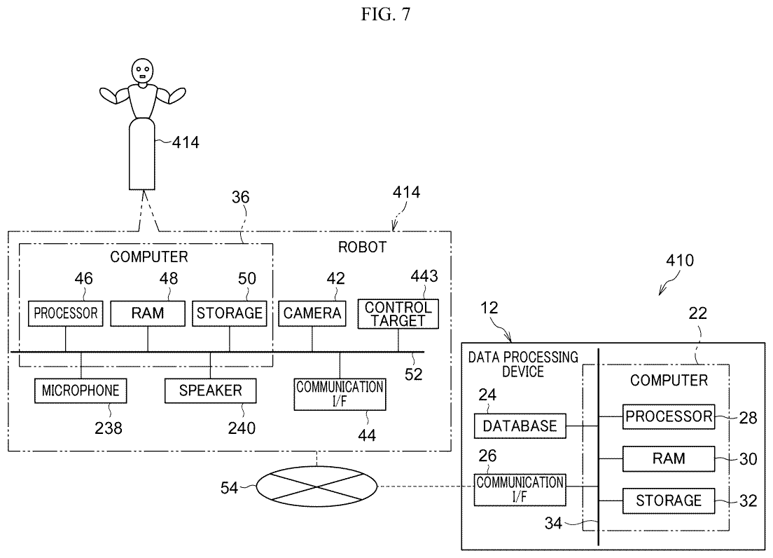

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

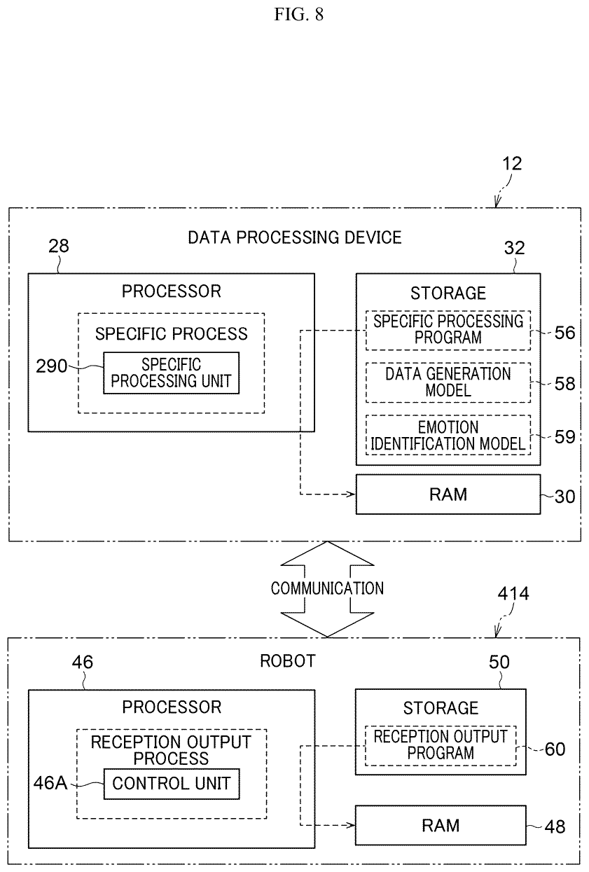

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

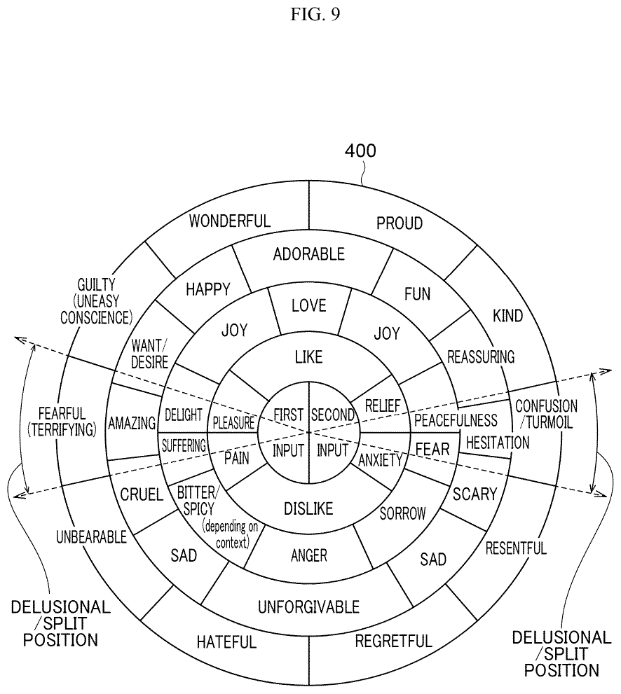

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

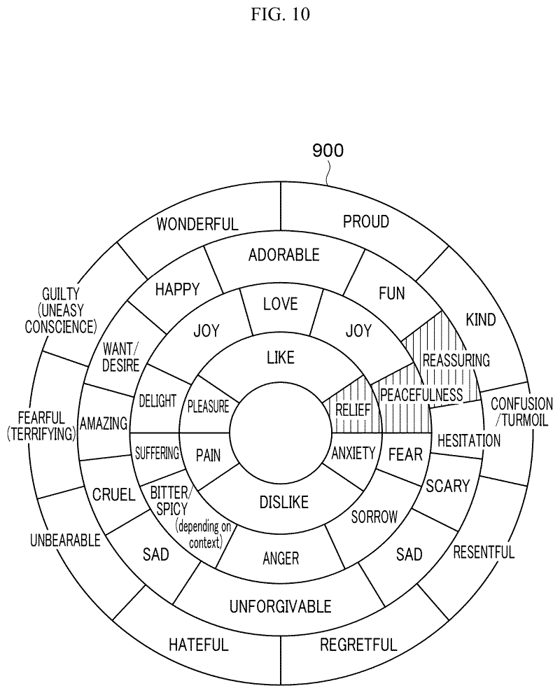

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive character information in a natural language from a user operating a user terminal via a communication network,
perform preprocessing on the received character information, the preprocessing including unifying character types, normalizing an encoding scheme, deleting unnecessary blank characters and control symbols, and converting full-width characters into half-width characters,
generate an instruction text including the preprocessed character information, the instruction text including an explanatory description that requests extraction of reservation-related date and time information, location information, facility name information, number-of-persons information, and condition information, and thereby generate a prompt sentence for extracting reservation information from the preprocessed character information,
transmit the generated prompt sentence as a communication request to a generative artificial intelligence model that executes natural language processing, and receive response data including the reservation information from the generative artificial intelligence model,
analyze the reservation information from the response data as structured data and categorize the reservation information into date data, time data, geographic region data, facility identification data, and number-of-persons data, and store the categorized reservation information in an internal storage,
convert the categorized reservation information into display data in a display format and transmit the display data to the user terminal so as to present, as confirmation information, the reservation information for confirmation or correction by the user,
package, in accordance with a communication specification of an external information processing system that executes reservation processing, reservation information that has been confirmed or corrected, as transmission data, and transmit the transmission data to the external information processing system by using a secure communication procedure, and analyze response data including a reservation processing result received from the external information processing system and generate result notification information for presentation of the reservation processing result on the user terminal.

### (Supplementary 2)

The system according to supplementary 1,
wherein the processor is configured to
cause the display format of the display data to include a standardized markup format that separates the reservation information by item, and to enable the user terminal to display the reservation information as an editable input region on a screen based on the standardized markup format.

### (Supplementary 3)

The system according to supplementary 1,
wherein the processor is configured to
when the response data from the generative artificial intelligence model is output as a structured representation including the reservation information, perform format verification and value validity determination on the structured representation, and, when it is determined that there is a missing item or an invalid item, add wording requesting additional input of the missing item to the prompt sentence and transmit the prompt sentence again to the generative artificial intelligence model.

### Application Example 1

### (Supplementary 1)

A system comprising a processor,
wherein the processor is configured to
receive, via a terminal, text data including a natural-language payment instruction from a user, and
preprocess the text data by performing normalization, tokenization, and removal of unnecessary information, generate a prompt sentence that instructs a generative AI model to extract payment-related information using a result of the preprocessing, and input the prompt sentence and the text data into the generative AI model to obtain candidate payment information including date-time information, location information, amount information, and payee information, and
integrate the candidate payment information obtained from the generative AI model with a result of syntactic analysis and attribute extraction performed by a machine-learning-based natural language processing library, and generate structured settlement data by performing conversion of date expressions into a standard format, normalization of an amount and a currency, and identification and matching of a payee name, and
generate settlement request data for an external electronic settlement service based on the structured settlement data, transmit the settlement request data to the external electronic settlement service via a communication interface using a secure communication protocol so as to cause execution of an electronic settlement process, and receive settlement result data from the external electronic settlement service, and
generate a text message including summary information of a settlement result using the settlement result data, reconstruct the text message into a natural expression by using, as needed, the generative AI model with a prompt sentence, and transmit the text message to the terminal of the user.

### (Supplementary 2)

The system according to supplementary 1,
wherein the processor is configured to
generate the structured settlement data as a data structure including a user identifier, a payee identifier, a settlement amount, a currency type, a scheduled settlement date-time, and a settlement content description, perform consistency verification of the data structure and detection of missing items before transmission to the external electronic settlement service, and transmit, when a missing item is detected, an additional-information input request message to the terminal of the user.

### (Supplementary 3)

The system according to supplementary 1,
wherein the processor is configured to
execute, using the settlement result data and the structured settlement data as inputs, at least one of a template-based text generation process and a text generation process using the generative AI model, and automatically generate a concise settlement result notification sentence suitable for a notification screen of a mobile terminal or a web terminal.

### Example 2

### (Supplementary 1)

A system comprising a processor,
wherein the processor is configured to
receive, from a terminal operated by a user, character information including a reservation request described in natural language,
perform preprocessing on the character information, the preprocessing including normalization processing, segmentation processing, and removal of unnecessary components, construct a prompt sentence for analyzing the preprocessed character information, and input the prompt sentence and the character information into a generative AI model so as to cause the generative AI model to analyze the character information and extract reservation information including at least a reservation date and time and a reservation place,
verify an analysis result obtained from the generative AI model by using language processing software, and normalize the reservation information based on a verification result,
convert the normalized reservation information into an information format requested by an external processing apparatus, generate transmission data, and transmit the transmission data to the external processing apparatus via a communication path,
acquire response information received from the external processing apparatus, convert the response information into character information, and transmit the character information to the terminal of the user.

### (Supplementary 2)

The system according to supplementary 1,
wherein the processor is configured to generate, based on the normalized reservation information and the response information received from the external processing apparatus, a structured document indicating a reservation result, and transmit the structured document to the terminal of the user for display.

### (Supplementary 3)

The system according to supplementary 1,
wherein the processor is configured to configure the transmission data as a request message based on a transfer control scheme when transmitting the reservation information to the external processing apparatus, and to perform transmission and reception in accordance with a communication standard having an encryption function.

### Application Example 2

### (Supplementary 1)

A system comprising a processor,
wherein the processor is configured to
receive text data in a natural language from a user,
perform preprocessing on the received text data, the preprocessing including unifying character types, segmenting the text data into words, and removing unnecessary words,
perform linguistic analysis on the preprocessed text data, the linguistic analysis including analyzing morphemes, assigning parts of speech to phrases, and analyzing dependency relationships between phrases, and extract candidate information including time information, location information, target information, and intent information,
perform emotion classification on the text data to identify emotion information contained in the text data and calculate an emotion type and an emotion intensity,
determine a priority of a reservation process or an order process based on the time information, the location information, the target information, and the emotion information,
generate a prompt sentence for a generative information processing model, the prompt sentence instructing the generative information processing model to extract reservation information and emotion information, using the preprocessed text data and the candidate information as inputs,
input the prompt sentence and the text data to the generative information processing model and obtain structured data including the reservation information and the emotion information, compare the structured data with the candidate information, evaluate inconsistencies between an output of the generative information processing model and the candidate information, and integrate and fix the time information, the location information, the target information, and the emotion information to generate fixed reservation information,
transmit reservation request data to an external communication processing program or an external reservation processing apparatus based on the fixed reservation information and the priority, and
convert reservation result data acquired from the external communication processing program or the external reservation processing apparatus into character information and generate display data for notification to a user terminal.

### (Supplementary 2)

The system according to supplementary 1,
wherein the processor is configured to
format the fixed reservation information and the reservation result data into a structured document format and transmit the structured document format to the user terminal so as to control display of the reservation information and the reservation result on a screen of the user terminal.

### (Supplementary 3)

The system according to supplementary 1,
wherein the processor is configured to
store the reservation request data in a communication request message, transmit the communication request message to the external reservation processing apparatus in accordance with a secure communication procedure, generate and append integrity check information for transmission data, and perform retransmission control or failure logging based on a communication result.

What is claimed is:

1. A system comprising:
a communication interface configured to communicate with a client terminal via a packet-switched network;
a storage device storing a data generation model obtained by training a neural network; and
circuitry configured to:
receive, from the client terminal via the communication interface, input data comprising a natural-language character string;
perform normalization preprocessing on the input data, the normalization preprocessing comprising at least character-type unification and encoding normalization, to generate preprocessed data;
generate a task-specific prompt by embedding the preprocessed data into an instruction template that specifies a structured output schema, the structured output schema defining a plurality of extraction fields;
transmit the task-specific prompt to the data generation model and receive, from the data generation model, response data comprising extracted values corresponding to the plurality of extraction fields;
validate the extracted values by verifying a format and a value range for each of the plurality of extraction fields, and, when a missing or invalid field is detected, generate a modified prompt requesting supplemental extraction and retransmit the modified prompt to the data generation model; and
transmit, to the client terminal via the communication interface, output data generated based on the validated extracted values.

2. The system according to claim 1,
wherein the normalization preprocessing further comprises removal of unnecessary blank characters and control symbols, conversion of full-width characters into half-width characters, and conversion of the input data to a standardized Unicode normalization form.

3. The system according to claim 2,
wherein the circuitry is further configured to perform tokenization on the preprocessed data by segmenting the preprocessed data into subword units, and to generate a feature vector from the subword units for input to the data generation model.

4. The system according to claim 1,
wherein the structured output schema defines the plurality of extraction fields as key-value pairs comprising at least a date field, a time field, a geographic region field, a facility identification field, and a quantity field, and wherein the response data comprises the extracted values formatted as a serialized data structure conforming to the structured output schema.

5. The system according to claim 4,
wherein the circuitry is further configured to apply deterministic parsing rules to the response data to locate field labels and extract corresponding values, convert the extracted values into typed data fields comprising at least a date type and a time type, and store the typed data fields in a structured data object in the storage device.

6. The system according to claim 5,
wherein the structured data object represents reservation information comprising at least one of a restaurant booking, a hotel booking, or a transportation booking, and wherein the facility identification field corresponds to a registered facility in a database accessible by the circuitry.

7. The system according to claim 1,
wherein the circuitry is further configured to convert the validated extracted values into display data formatted in a standardized markup format, and to transmit the display data to the client terminal via the communication interface, the display data causing the client terminal to render editable regions corresponding to the plurality of extraction fields for user confirmation or correction.

8. The system according to claim 7,
wherein the circuitry is further configured to receive, from the client terminal via the communication interface, confirmed or corrected values for the plurality of extraction fields, merge the confirmed or corrected values into the structured data object, and perform a final validation pass on the merged data.

9. The system according to claim 8,
wherein the circuitry is further configured to package the validated merged data into a payload conforming to a communication specification of an external processing system, and to transmit the payload to the external processing system via a secure communication protocol comprising at least Transport Layer Security.

10. The system according to claim 9,
wherein the circuitry is further configured to receive a processing result from the external processing system, extract a confirmation identifier from the processing result, and transmit result notification data comprising the confirmation identifier to the client terminal via the communication interface.

11. The system according to claim 1,
wherein the data generation model comprises a transformer-based large language model, and wherein the task-specific prompt further comprises a temperature parameter configured to reduce randomness of the response data, and a maximum output length parameter.

12. The system according to claim 1,
wherein the circuitry is further configured to estimate an emotion of a user of the client terminal by applying an emotion identification model to sensor data received from the client terminal via the communication interface, the sensor data comprising at least one of voice data, biometric data, or facial expression data.

13. The system according to claim 12,
wherein the circuitry is further configured to adjust at least one of a detail level of the output data, a response timing, or a presentation format of the output data based on the estimated emotion.

14. The system according to claim 12,
wherein the emotion identification model maps the sensor data to coordinates on a two-dimensional emotion space defined by a valence axis and an arousal axis, the coordinates indicating the estimated emotion.

15. The system according to claim 1,
wherein the client terminal comprises at least one of a smart device, smart glasses, a headset-type terminal, or a robot, and wherein the communication interface is configured to communicate with the client terminal via at least one of a Fifth Generation Mobile Communication System, Wi-Fi, or Bluetooth communication standard.

16. The system according to claim 1,
wherein the circuitry is further configured to store interaction history data comprising pairs of the input data and the output data in a database, and to retrieve the interaction history data when generating a subsequent task-specific prompt to provide conversational context to the data generation model.

17. The system according to claim 1,
wherein the circuitry is further configured to receive, from the client terminal via the communication interface, image data captured by a camera of the client terminal, extract additional structured data from the image data by performing at least one of optical character recognition or code decoding, and incorporate the additional structured data into the task-specific prompt.

18. A system comprising:
a communication interface configured to communicate with a client terminal via a packet-switched network conforming to at least one of a Fifth Generation Mobile Communication System, Wi-Fi, or Bluetooth communication standard;
a storage device storing a data generation model comprising a transformer-based neural network obtained by deep learning, and an emotion identification model; and
circuitry configured to:
receive, from the client terminal via the communication interface, input data comprising a natural-language character string representing a user request;
perform normalization preprocessing on the input data, the normalization preprocessing comprising character-type unification, encoding normalization, removal of unnecessary blank characters and control symbols, and conversion of full-width characters into half-width characters;
generate a task-specific prompt by embedding preprocessed data obtained from the normalization preprocessing into an instruction template, the instruction template specifying a structured output schema that defines a plurality of extraction fields as key-value pairs;
transmit the task-specific prompt to the data generation model and receive response data comprising extracted values formatted as a serialized data structure;
validate the extracted values by verifying a format and a value range for each extraction field, and iteratively refine the task-specific prompt when a missing or invalid field is detected;
estimate an emotion of a user by applying the emotion identification model to sensor data received from the client terminal; and
transmit, to the client terminal via the communication interface, output data generated based on the validated extracted values, a presentation format of the output data being adjusted based on the estimated emotion.

19. The system according to claim 18,
wherein the circuitry is further configured to convert the validated extracted values into display data formatted in a standardized markup format for user confirmation, receive confirmed values from the client terminal, package the confirmed values into a payload conforming to a communication specification of an external processing system, and transmit the payload via a secure communication protocol comprising Transport Layer Security.

20. A method performed by a system comprising a communication interface and circuitry, the method comprising:
receiving, from a client terminal via the communication interface and a packet-switched network, input data comprising a natural-language character string;
performing normalization preprocessing on the input data, the normalization preprocessing comprising at least character-type unification and encoding normalization, to generate preprocessed data;
generating a task-specific prompt by embedding the preprocessed data into an instruction template that specifies a structured output schema defining a plurality of extraction fields;
transmitting the task-specific prompt to a data generation model stored in a storage device of the system, and receiving, from the data generation model, response data comprising extracted values corresponding to the plurality of extraction fields;
validating the extracted values by verifying a format and a value range for each of the plurality of extraction fields, and, when a missing or invalid field is detected, generating a modified prompt and retransmitting the modified prompt to the data generation model; and
transmitting, to the client terminal via the communication interface, output data generated based on the validated extracted values.
